(19) United States
(12) Patent Application Publication
(10) Pub. No.: US 2014/0288675 A1
(43) Pub. Date: Sep. 25, 2014

(54) Diagnostic Processing System, Onboard Terminal System, and Server

(71) Applicant: Hitachi Construction Machinery Co., Ltd., Tokyo (JP)

(72) Inventors: Junsuke FUJIWARA, Tokyo (JP); Hideaki SUZUKI, Tokyo (JP); Takayuki UCHIDA, Tokyo (JP); Tomoaki HIRUTA, Tokyo (JP)

(73) Assignee: Hitachi Construction Machinery Co., Ltd., Tokyo (JP)

(21) Appl. No.: 14/183,978

(22) Filed: Feb. 19, 2014

(30) Foreign Application Priority Data
Mar. 25, 2013 (JP) 2013-062144

(51) Int. Cl. G05B 9/02; G06F 11/07

(52) U.S. Cl. CPC G05B 9/02; G06F 11/0748
USPC 700/79

(57) ABSTRACT

Disclosed is a diagnostic processing system including an onboard terminal system and a server connected together via radio communication channels. The onboard terminal system is provided with a data receiving unit for receiving data from sensors arranged on a self-propelled machine and a first diagnostic unit for diagnosing an abnormality of the self-propelled machine, and the server is provided with a second diagnostic unit for diagnosing the abnormality of the self-propelled machine. The diagnostic processing system is configured such that one of the first diagnostic unit and second diagnostic unit performs a primary diagnosis as to the abnormality of the self-propelled machine based on the data received at the data receiving unit and transmits a result of the primary diagnosis to the other diagnostic unit, and upon receipt of the result of the primary diagnosis, the other diagnostic unit performs a secondary diagnosis based on the result of the primary diagnosis.

### CROSS-REFERENCE TO RELATED APPLICATION

This application claims the priority of Japanese Patent Application 2013-62144 filed Mar. 25, 2013, which is incorporated herein by reference.

### BACKGROUND OF THE INVENTION

1. Field of the Invention

This invention relates to a diagnostic processing system for diagnosing an abnormality of a self-propelled machine, and also to an onboard terminal system and server useful in the diagnostic processing system.

2. Description of the Related Art

Working machines (self-propelled machines) useful in mines and the like, such as excavators and dump trucks, are operating all over the world for earth or stone excavation work, haulage work and so on, and in many instances, are required to perform continuous operation for improved productivity. If an unexpected failure occurs, it becomes necessary to stop the working machine for an inspection and for maintenance or a parts replacement so that the productivity is significantly lowered. To obviate such an unexpected failure, diagnostic processing systems have been configured to quickly detect an abnormality of a working machine.

According to these diagnostic processing systems, operation data of a working machine are acquired, for example, from sensors arranged on an engine, hydraulic system and the like of the working machine, and a diagnostic processing program is executed using the operation data as inputs. The configuration of such a diagnostic processing system makes it possible to quickly detect an abnormality as a foretaste for a serious failure. By taking a measure for the abnormality at an early stage, an advantageous effect is brought about in that the downtime of the working machine is shortened.

Depending on the difference in configuration, these diagnostic processing systems can be roughly divided into two groups. One of the groups includes systems that execute diagnostic processing by an onboard terminal system mounted on a working machine (hereinafter called “mounted diagnostic systems”), while the other group include systems that execute diagnostic processing by a server arranged at a place remote from a working machine (hereinafter called “server's installed diagnostic systems”).

A mounted diagnostic system can perform in situ diagnostic processing of sensor data acquired from its associated working machine, and therefore, can perform a reliable diagnosis irrespective of the availability and status of radio communication infrastructure at a mine or the like (see JP-A-2006-144292).

On the other hand, a server's installed diagnostic system transfers sensor data, which have been acquired at an onboard terminal system, to a server via radio communication channels, and performs diagnostic processing on the side of the server. No particular restriction is imposed especially from the standpoint of performance in performing the diagnostic processing, for example, provided that a cloud computing technology involving a plurality of computers is used. The server's installed diagnostic system, therefore, can also perform detailed diagnostic processing that requires heavy processing, such as the estimation of a fault part.

### SUMMARY OF THE INVENTION

As has been described above, the diagnostic processing systems include the two groups of systems, which are accompanied by the following problems, respectively.

First, if an attempt is made to perform detailed diagnostic processing with a mounted diagnostic system, a problem arises in that a large processing load is applied to an onboard terminal system. The performance of detailed diagnostic processing by a server's installed diagnostic system involves a similar problem that a large processing load is applied to the server.

Next, the mounted diagnostic system is accompanied by a practical problem in that compared with the server's installed diagnostic system, it is difficult to perform a detailed diagnosis because of the imposition of a restriction on the processing performance of the onboard terminal system. Even if an abnormality is detected, sufficient information required for maintenance cannot hence be obtained, and as a consequence, a potential problem may arise in that sufficient lead time would hardly be assured for the avoidance of a machine stoppage.

In the case of the server's installed diagnostic system, on the other hand, it is necessary to transfer sensor data without any fault to the server because a diagnosis is to be performed on the side of the server. When the working machine is performing work, for example, at a worksite where the communication status of radio communication channels is not good, the server cannot receive such sensor data without any fault, leading to a problem that no diagnostic processing can be performed. Especially at a place with significant terrain changes such as a mine or the like, it is not easy to assure sufficient radio communication quality.

For the foregoing reasons, a diagnostic processing system is required to reduce the processing loads of the onboard terminal system and server. In addition, the diagnostic processing system is also required to be capable of surely performing diagnostic processing irrespective of changes in the communication environment.

With a view to providing a solution to the above-described problems, a first object of the present invention is to provide a diagnostic processing system that can reduce the processing loads of an onboard terminal system and server. Further, second and third objects of the present invention are to provide an onboard terminal system and server suited for the diagnostic processing system.

To achieve the above-described first object, the present invention provides a diagnostic processing system comprising an onboard terminal system, which is mounted on a self-propelled machine, and a server, which is arranged at a control center, connected together via radio communication channels, wherein the onboard terminal system is provided with a data receiving unit for receiving data from sensors arranged on the self-propelled machine and a first diagnostic unit for diagnosing an abnormality of the self-propelled machine, the server is provided with a second diagnostic unit for diagnosing the abnormality of the self-propelled machine, and one of the first diagnostic unit and second diagnostic unit performs a primary diagnosis of the abnormality of the self-propelled machine based on the data received at the data receiving unit and transmits a result of the primary diagnosis to the other diagnostic unit, and upon receipt of the result of the primary diagnosis, the other diagnostic unit performs a secondary diagnosis based on the results of the primary diagnosis.

As the primary diagnosis and secondary diagnosis can be separately processed by the first diagnostic unit and second diagnostic unit, respectively, the diagnostic processing system according to the present invention can reduce the processing loads of both the onboard terminal system and the server.

In the above-described configuration, it is preferred to configure such that the first diagnostic unit performs the primary diagnosis, the second diagnostic unit performs the secondary diagnosis upon receipt of the result of the primary diagnosis by the first diagnostic unit, and based on satisfaction of a predetermined condition, the first diagnostic unit further also performs the secondary diagnosis.

According to this configuration, it is possible to reliably perform up to the secondary analysis even when the predetermined condition is satisfied. Described specifically, the onboard terminal system normally handles the processing of the primary diagnosis, but upon satisfaction of the predetermined condition, the onboard terminal system also handles the processing of the secondary diagnosis although it is normally handled by the server. The system is, therefore, provided with improved reliability.

In the above-described configuration, it is preferred to configure such that the primary diagnosis is a simple diagnosis that performs a predetermined diagnostic content by using a simple method, the secondary diagnosis is a detailed diagnosis that performs the predetermined diagnostic content by using a detailed method, and the first diagnostic unit or second diagnostic unit performs the secondary diagnosis only when the self-propelled machine has been found to be abnormal as a result of the primary diagnosis.

According to this configuration, the level of diagnosis is set different between the primary diagnosis and secondary diagnosis so that the system can be made more efficient. With this configuration, a limitation is also imposed on

the case where the secondary diagnosis is performed, thereby enabling further reductions of the processing loads of the onboard terminal system and server.

In the above-described configuration, a method that compares the data with a predetermined threshold may be used as the simple method, and a method that subjects the data to a multivariate analysis may be used as the detailed method. This configuration can make up a suitable diagnostic processing system.

In the above-described configuration, the predetermined diagnostic content may preferably be set for every operation mode of the self-propelled machine, because this configuration can determine an abnormality of the self-propelled machine in detail and can provide the system with further improved reliability.

In the above-described configuration, the predetermined diagnostic content may preferably be set for every diagnosis target of the self-propelled machine, because this configuration can determine an abnormality of the self-propelled machine in detail and can provide the system with further improved reliability. It is to be noted that “diagnostic target” may hereinafter also be referred to as “part”, “system” or “part/system”.

In the above-described configuration, it is preferred that the self-propelled machine is a hydraulic excavator, at least an engine and a hydraulic system are included as diagnosis targets, and items for detecting an abnormality of a cooling system, an abnormality of an intake system and an abnormality of an exhaust temperature in the engine and an item for detecting an abnormality of a hydraulic oil cooling system in the hydraulic system are included as predetermined diagnostic contents, because this configuration is suited when an abnormality of the hydraulic excavator is diagnosed.

In the above-described configuration, it is preferred that the onboard terminal system is provided with a communication status determination unit for determining a communication status of the radio communication channels, and that the predetermined condition is supposed to be satisfied when the radio communication status of the communication channels is determined to be not good by the communication status determination unit. According to this configuration, it is possible to change, depending on the communication status, whether the onboard terminal system performs only the primary diagnosis or performs up to the secondary diagnosis. A system suited especially for a site where the communication status is unstable can be provided accordingly.

To achieve the above-described second object, the present invention also provides an onboard terminal system to be mounted on a self-propelled machine to perform communication with a server, which is arranged at a control center, via radio communication channels, wherein the onboard terminal system is provided with a data receiving unit for receiving data from sensors arranged on the self-propelled machine, a first diagnostic unit for performing, based on the data received from the data receiving unit, a primary diagnosis as to an abnormality of the self-propelled machine,

a first communication unit for transmitting, to the server, results of the primary diagnosis at the first diagnostic unit, and a communication status determination unit for determining a communication status of the radio communication channels; and the first diagnostic unit further performs, according to a result of the determination the communication status determination unit, a secondary diagnosis as to the abnormality of the self-propelled machine.

The onboard terminal system according to the present invention is configured to normally perform the primary diagnosis, and depending on the result of the determination at the communication status determination unit, to also perform the secondary diagnosis. The processing load is, therefore, reduced compared with the case where the primary diagnosis and secondary diagnosis are always performed. Especially at a site where the communication status is unstable, the onboard terminal system may become impossible to transmit the result of the primary diagnosis to the server in some instances. Even in such instances, the present invention can reliably determine the abnormality of the self-propelled machine, because the first diagnostic unit is configured to further enable the secondary diagnosis.

To achieve the above-described third object, the present invention also provides a server to be arranged at a control center to perform communication with an onboard terminal system, which is mounted on a self-propelled machine, via radio communication channels, wherein:

the server is provided with an input unit for inputting a condition for a primary diagnosis to be performed at the onboard terminal system as to an abnormality of the self-propelled machine, a second communication unit for transmitting, to the onboard terminal system, the condition for the primary analysis as inputted at the input unit and also for receiving, from the onboard terminal system, results of the primary diagnosis performed at the onboard terminal system, and a second diagnostic unit for performing a secondary diagnosis as to the abnormality of the self-propelled machine based on the result of the first diagnosis as received at the second communication unit.

Because the server according to the present invention handles only the secondary diagnosis (the primary diagnosis is handled by the onboard terminal system), the processing load is reduced compared with the case where a server handles the primary diagnosis and secondary diagnosis. A diagnosis suited to the working environment of a site is also feasible, because the server according to the present invention can set the condition for the primary diagnosis and can transmit it to the onboard terminal system.

According to the present invention, a diagnostic processing system with reduced processing loads on an onboard terminal system and server can be provided. It is to be noted that problems, configurations and advantageous effects other than those described above will become apparent from the description of the following embodiment.

### BRIEF DESCRIPTION OF THE DRAWINGS

FIG. 1 is an overall configuration diagram of a diagnostic processing system according to an embodiment of the present invention.

FIG. 2 is a configuration diagram of a control network in each hydraulic excavator shown in FIG. 1.

FIG. 3 is a configuration diagram of a hydraulic oil cooling system in a hydraulic system of each hydraulic excavator shown in FIG. 1.

FIG. 4 is a configuration diagram of a cooling system and intake system of an engine in each hydraulic excavator shown in FIG. 1.

FIG. 5 is a configuration diagram of a control network in each dump truck shown in FIG. 1.

FIG. 6 is a block diagram depicting an electrical configuration of the diagnostic processing system according to the embodiment of the present invention.

FIG. 7 is a diagram illustrating a configuration example of operation data transmitted from various sensors to an operation data receiving unit depicted in FIG. 6.

FIG. 8 is a diagram illustrating a configuration example of data in a sensor information storage unit of an onboard terminal depicted in FIG. 6.

FIG. 9 is a diagram illustrating a data configuration example of a diagnostic condition table for the onboard terminal as stored in a diagnostic condition storage unit of the onboard terminal depicted in FIG. 6.

FIG. 10 is a diagram illustrating a data configuration example of a diagnostic item table stored in the diagnostic condition storage unit of the onboard terminal depicted in FIG. 6.

FIG. 11 is a diagram illustrating a data configuration example of a diagnostic model table stored in the diagnostic condition storage unit of the onboard terminal depicted in FIG. 6.

FIG. 12 is a flow chart illustrating the procedure of diagnostic processing to be performed by a diagnostic processing unit on the side of the onboard terminal depicted in FIG. 6.

FIG. 13 is a flow chart illustrating the procedure of diagnosis execution processing illustrated in FIG. 12.

FIG. 14 is a diagram illustrating the format of data to be transmitted from the onboard terminal depicted in FIG. 6 to a server.

FIG. 15 is a diagram illustrating the configuration of data in a management information storage unit of the server depicted in FIG. 6.

FIG. 16 is a flow chart illustrating the procedure of diagnostic processing to be performed by a diagnostic processing unit on the side of the server depicted in FIG. 6.

### DETAILED DESCRIPTION OF PREFERRED EMBODIMENTS

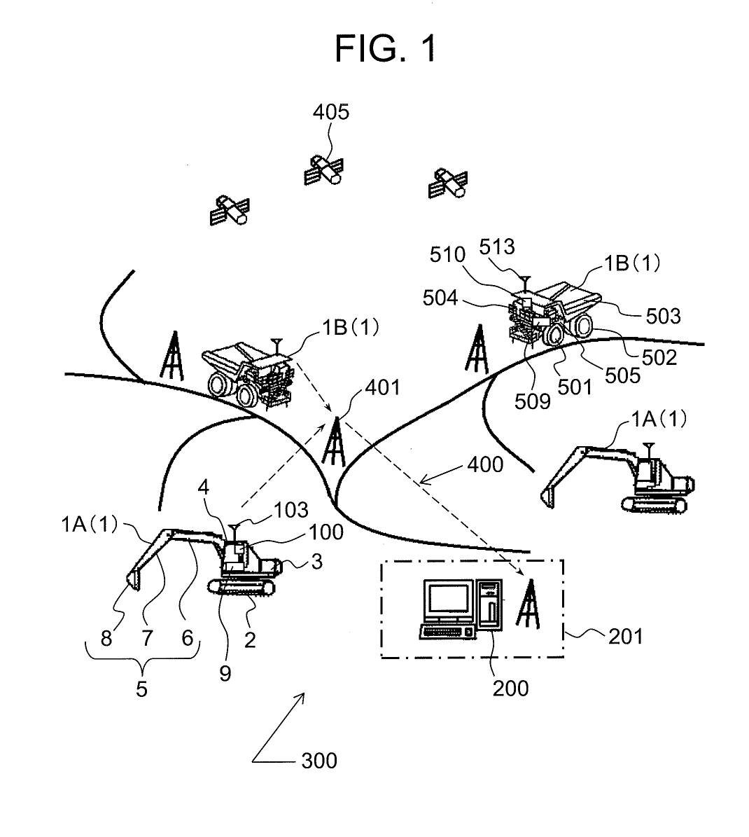

With reference to the drawings, the present invention will hereinafter be described about an embodiment applied to a system for diagnosing an abnormalities of working machines used in a mine or the like, such as excavators and dump trucks. FIG. 1 is a schematic diagram showing the overall configuration of a diagnostic processing system according to the embodiment of the present invention.

As shown in FIG. 1, in amine quarry, working machines (self-propelled machines) 1 such as excavators 1A and dump trucks 1B are used, and a diagnostic processing system 300 is employed to diagnose abnormalities of these working machines. In this diagnostic processing system 300, a server 200 is arranged at a control center 201 located near to or far from the quarry. Mounted on each working machine 1 are a position acquiring unit (now shown) for acquiring the position of the working machine itself by using GPS satellites 405, and various sensors (now shown). Onboard terminals (onboard terminal systems) 100,510 of the respective working machines 1 are configured to transmit various data, diagnostic results and the like to the server 200 via radio communication channels 400. It is to be noted that numeral 401 indicates a relay station.

Each excavator 1A is a super-large hydraulic excavator, and is constructed with a travel base 2, an upperstructure 3 swingably mounted on the travel base 2, an operator's cab 4, and a front working mechanism 5 centrally arranged on a front section of the upperstructure 3. The front working mechanism 5 is composed of a boom 6 arranged pivotally on the upperstructure 3, an arm 7 arranged pivotally on a free end of the boom 6, and a bucket 8 attached to a free end of the arm 7. In the operator's cab 4, a controller network 9 is arranged to collect a status variable relating to an operation status of each part of the excavator 1A. It is to be noted that the onboard terminal 100 is arranged in the operator's cab 4 and that an antenna 103 is arranged at a good visibility position, for example, on a top portion of the operator's cab 4.

On the other hand, each dump truck 1B is constructed with a frame 505 forming a main body, an operator's cab 504, front wheels 501 and rear wheels 502, a load body 503 pivotable in an up-and-down direction about hinge pins (not shown) arranged as centers of pivotal motion on a rear section of the frame 505, and a pair of left and right hoist cylinders (not shown) for pivoting the load body 503 in the up-and-down direction. In the operator's cab 504, a controller network 509 is arranged to collect a status variable relating to an operation status of each part of the dump truck 1B. It is to be noted that the onboard terminal 510 is arranged in the operator's cab 504 and that an antenna 513 is arranged at a good visibility position, for example, on a top portion of the operator's cab 504.

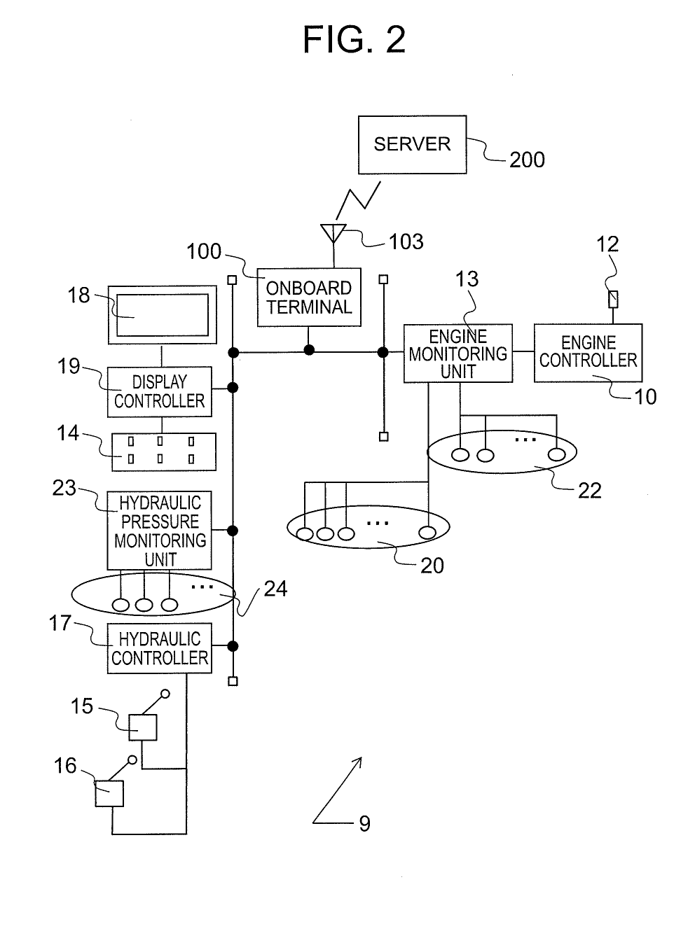

Referring to FIG. 2, a description will be next made of a configuration example of the controller network 9 of the excavator 1A. As illustrated in FIG. 2, the controller network 9 is composed of an engine controller 10, an injection quantity controller 12, an engine monitoring unit 13, an electric control lever 15 for operating the travel base 2, an electric control lever 16 for operating the front working mechanism 5, a hydraulic controller 17 for performing hydraulic control according to manipulation strokes of the electric control levers 15,16, a display 18, a display controller 19, a keypad 14, a hydraulic pressure monitoring unit 23, and the onboard terminal 100.

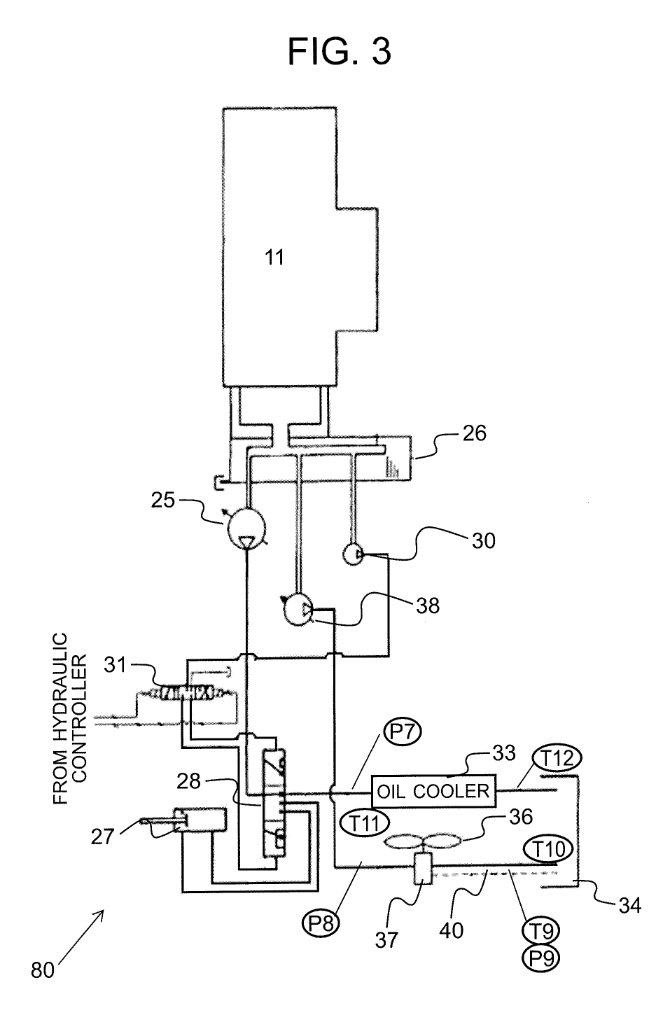

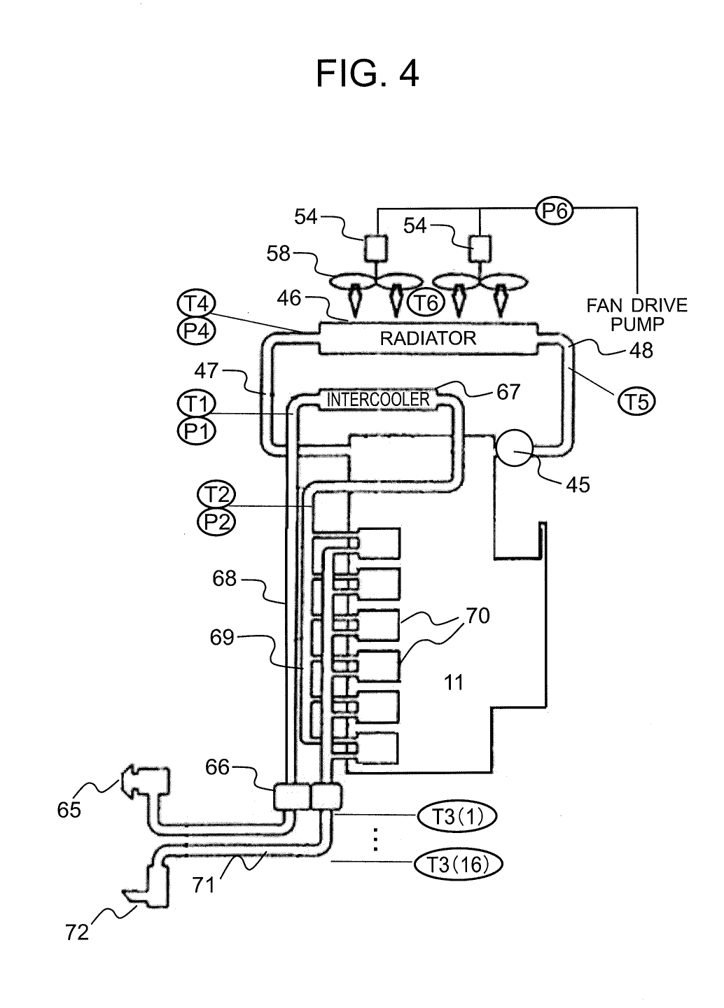

The engine controller 10 is a device that controls the injection quantity controller 12 to govern the quantity of fuel to be injected into an engine 11 (see FIGS. 3 and 4). The engine monitoring unit 13 acquires, from various sensors, status variables relating to an operation status of the engine 11, and performs monitoring. As examples of the sensors for detecting the operation status of the engine 11, a sensor group 20 for sensing an operation status of an intake/exhaust system of the engine and a sensor group 22 for sensing an operation status of a cooling system of the engine are connected to the engine monitoring unit 13.

Included in the sensor group 20 relating to the intake/exhaust system of the engine 11 are, as will be described subsequently herein, an intercooler inlet temperature sensor T1, intercooler inlet pressure sensor P1, intercooler outlet temperature sensor T2 and intercooler outlet pressure sensor P2, which are arranged at an inlet and outlet of an intercooler for cooling air to be drawn into the engine 11, exhaust temperature sensors T3(1)-T3(16) for detecting the temperatures of exhaust from individual cylinders, the number of which is assumed to be 16, of the engine 11, and the like. Included in the sensor group 22 associated with the cooling system of the engine 11 are, as will also be described subsequently herein, a radiator inlet temperature sensor T4, radiator inlet pressure sensor P4, radiator outlet temperature sensor T5 and the like, which are arranged before and after a radiator for cooling coolant that circulates through the engine 11.

The engine controller 10 and the engine monitoring unit 13 are connected via a communication line, and the engine monitoring unit 13 and the onboard terminal 100 are connected via a network line. By taking such configuration, status variables relating to operation statuses of the intake/exhaust system and cooling system of the engine 11 as detected by the various sensors can be transmitted to the onboard terminal 100.

The display 18 is arranged in the operator's cab 4, and displays various operation information of the excavator 1A. The display controller 19 is connected to the display 18, and controls displaying. The keypad 14 is connected to the display controller 19, and serves to perform setting of various data, screen switching of the display 18, and the like by manipulated inputs from an operator.

The hydraulic pressure monitoring unit 23 is a device that performs monitoring of status variables relating to the operation status of a hydraulic system 80 (see FIG. 3) in the excavator 1A. To the hydraulic pressure monitoring system 23, a variety of sensors are connected to sense the operation status of the hydraulic system, for example, a sensor group 24 is connected to sense the operation status of a hydraulic oil cooling system. Included in the sensor group 24 for sensing the operation status of the hydraulic oil cooling system are, as will be described subsequently herein, an oil cooler inlet pressure sensor P7, an oil cooler outlet temperature sensor T12, a hydraulic oil temperature sensor T10 for detecting the temperature of hydraulic oil, and the like.

The hydraulic pressure monitoring unit 23 and the onboard terminal 100 are connected via the network line. With respect to a status variable relating to an operation status of the hydraulic oil cooling system as detected by the hydraulic pressure monitoring unit 23, it is also configured to enable its transmission to the onboard terminal 100.

The onboard terminal 100 is connected to the hydraulic pressure monitoring unit 23 and engine monitoring system 13 via the network line, and receives sensor data relating to the operation status of the hydraulic system, for example, the hydraulic oil cooling system from the hydraulic pressure monitoring unit 23, and also, sensor data relating to the operation status of the engine 11, for example, the intake/exhaust system and cooling system from the engine monitoring system 13. By a comparison between the sensor data so received and the corresponding normal reference values for each diagnostic item, the onboard terminal 100 performs diagnostic processing on the operation status.

The onboard terminal 100 is also connected to the display controller 19 via the network line, and may be configured to transmit diagnostic results to display them on the display 18. The onboard terminal 100 is also connected to the antenna 103 through which external communication can be performed. By being connected to the external server 200 and performing communication, the onboard terminal 100 can perform the transmission and reception of operation data, diagnostic results, diagnostic conditions and the like.

FIG. 3 is a conceptual configuration diagram, which illustrates the overall outline configuration of the hydraulic oil cooling system in the hydraulic system 80 of the excavator 1A and also indicates the arrangement positions of the individual sensors in the sensor group 24 for sensing the operation status of the hydraulic oil cooling system. In FIG. 3, there are illustrated the engine 11 mounted on the upperstructure 3 of the excavator 1A, a main pump 25 drivable by rotational drive force of a crankshaft (not shown) of the engine 11 via a pump transmission 26, and an actuator (for example, a boom cylinder, arm cylinder, or the like) 27 drivable by hydraulic oil delivered from the main pump 25.

There are also illustrated a control valve 28 connected to a delivery line of the main pump 25 to control the flow rate and flow direction of hydraulic oil from the main pump 25 to the actuator 27, a pilot pump 30 drivable, like the above-described main pump 25, by rotational drive force of the crankshaft of the engine 11 via the pump transmission 26 to produce an initial pilot pressure for switchingly drive the control valve 28, and a pilot-operated reducing valve 31 connected to a delivery line of the pilot pump 30 to reduce the initial pilot pressure, which has been produced by the pilot pump 30, according to a control signal from the hydraulic controller 17.

There are further illustrated an oil cooler 33 arranged between the control valve 28 and a hydraulic oil tank 34 to cool hydraulic oil, an oil cooler cooling fan 36 for producing cooling air to cool the oil cooler 33, an oil cooler fan drive motor 37 for driving the oil cooler cooling fan 36, an oil cooler fan drive pump 38 drivable by rotational drive force of the crankshaft (now shown) of the engine 11 to feed, via a delivery line, hydraulic oil for driving the oil cooler fan drive motor 37, and a drain line 40 of the oil cooler fan drive motor 37.

For the sake of convenience, FIG. 3 illustrates only one actuator, and corresponding to the single actuator, only one control valve and only one pilot-operated reducing valve. Actually, however, many actuators are mounted on the excavator 1A, and hydraulic devices such as control valves and pilot-operated reducing valves are arranged corresponding to such many actuators.

A description will next be made about the various sensors in the hydraulic oil cooling system of the hydraulic system 80 of FIG. 3. In FIG. 3, there are illustrated the hydraulic oil temperature sensor T10 for detecting the temperature of hydraulic oil in the hydraulic oil tank 34, an oil cooler front face temperature sensor T11 for detecting the temperature of air at a position very close to a front face of the oil cooler 33, said front face being opposite to the oil cooler cooling fan 36, and the oil cooler output temperature sensor 112 arranged in a downstream-side line of the oil cooler 33 to detect the temperature of hydraulic oil flowing out from the oil cooler 33. Designated at sign T9 is a fan motor drain temperature sensor arranged in the drain line 40 of the oil cooler fan drive motor 37 to detect the drain temperature of the oil cooler fan drive motor 37.

Designated at sign P7 is the oil cooler inlet pressure sensor arranged in an upstream-side line of the oil cooler 33 to detect the pressure of hydraulic oil flowing into the oil cooler 33. Sign P8 indicates a fan motor inlet pressure sensor for detecting the pressure of hydraulic oil flowing into the oil cooler fan drive motor 37. Indicated at sign P9 is a fan motor drain pressure sensor arranged in the drain line 40 of the oil cooler fan drive motor 37 to detect the drain pressure of the oil cooler fan drive motor 37.

Status variables acquired by the respective sensors included in the sensor group 24 (see FIG. 2) for detecting the operation status of the working oil cooling system, specifically sensor data of the hydraulic oil temperature detected by the hydraulic oil temperature sensor T10, the oil cooler front face temperature detected by the oil cooler front face temperature sensor T11, the oil cooler outlet temperature detected by the oil cooler outlet temperature sensor T12, the fan drive motor drain temperature detected by the fan motor drain temperature sensor T9, the oil cooler inlet pressure detected by the oil cooler inlet pressure sensor P7, the fan drive motor inlet pressure detected by the fan motor inlet pressure sensor P8, and the fan drive motor drain pressure detected by the fan motor drain pressure sensor P9 are inputted to the hydraulic pressure monitoring unit 23. The hydraulic pressure monitoring unit 23 then transmits the thus-inputted sensor data as sensing data, which relate to the hydraulic oil cooling system of the hydraulic system 80, to the onboard terminal 100 via the network line.

FIG. 4 is a conceptual configuration diagram, which conceptually illustrates the overall configuration of the cooling system and intake/exhaust system of the engine 11 in the excavator 1A and also indicates the arrangement positions of the various sensors in the sensor group 20 and sensor group 22 for sensing the operation statuses of the cooling system and intake/exhaust system. Based on FIG. 4, a description will first be made of the cooling system of the engine 11. In FIG. 4, there are illustrated a coolant pump 45 drivable via the pump transmission 26 by using rotational drive force of the crankshaft of the engine 11, and a radiator 46 for cooling coolant delivered from the coolant pump 45 and heated as a result of the cooling of the engine 11.

Numeral 47 designates a radiator inlet line connected to an inlet of the radiator 46, and numeral 48 indicates a radiator outlet line connected to an outlet of the radiator 46. Numeral 54 designates radiator cooling fan drive motors drivable by pressure oil from an unillustrated fan drive pump, and numeral 58 indicate radiator cooling fans drivable by the radiator cooling fan drive motors 54 to produce wind for cooling the radiator 46.

A description will next be made about the various sensors in the cooling system of the engine 11 as illustrated in FIG. 4. Sign T6 designates a radiator front face air temperature sensor for detecting the temperature of air at a position very close to a front face of the radiator 46, said front face being on the side of the radiator cooling fan drive motors 54. Sign T4 indicates the radiator inlet temperature sensor arranged in the radiator inlet line 47 to detect the temperature of coolant flowing into the radiator 46. Sign T5 designates the radiator outlet temperature sensor arranged in the radiator outlet line 48 to detect the temperature of coolant flowing out from the radiator 46.

There are also illustrated the radiator inlet pressure sensor P4 arranged in the radiator inlet line 47 to detect the pressure of coolant flowing into the radiator 46, and a fan drive motor inlet pressure sensor P6 arranged in an inlet line to the radiator cooling fan drive motors 54 to detect the pressure of pressure oil flowing into the radiator cooling fan drive motors 54.

Status variables acquired by the respective sensors included in the sensor group 20 (see FIG. 2) for detecting the operation status of the cooling system of the engine 11, specifically sensor data of the radiator front face air temperature detected by the radiator front face air temperature sensor T6, the radiator inlet temperature detected by the radiator inlet temperature sensor T4, the radiator outlet temperature detected by the radiator outlet temperature sensor T5, the radiator inlet pressure detected by the radiator inlet pressure sensor P4, and the fan motor inlet pressure detected by the fan drive motor inlet pressure sensor P6 are inputted to the engine monitoring unit 13. The engine monitoring unit 13 then transmits the thus-inputted sensor data as sensing data, which relate to the cooling system of the engine 11, to the onboard terminal 100 via the network line.

Based on FIG. 4, a description will next be made of the intake/exhaust system of the engine 11. In FIG. 4, there are illustrated an air cleaner 65, a turbocharger 66 for compressing air drawn from the air cleaner 65, an intercooler 67 for conducting cooling of air compressed in the turbocharger 66 and to be drawn into the engine 11, an intercooler inlet line 68 connected to an inlet of the intercooler 67, and an intercooler outlet line 69 connected to an outlet of the intercooler 67. Designated at numeral 70 are plural cylinders disposed in the engine 11 to draw air, which has been cooled in the intercooler 67, thereinto and to mix it with fuel for combustion. There are also illustrated exhaust pipes 71 for performing the exhaust of combustion gas produced in the se plural cylinders 70, and a muffler 72.

A description will next be made about the various sensors in the intake/exhaust system of the engine 11 of FIG. 4. Illustrated are the intercooler inlet pressure sensor P1 arranged in the intercooler inlet pipe 68 and the intercooler inlet temperature sensor 11 arranged likewise in the intercooler inlet pipe 68. Also illustrated are the intercooler outlet pressure sensor P2 arranged in the intercooler outlet line 69 and the intercooler outlet temperature sensor T2 arranged likewise in the intercooler outlet line 69. Further illustrated are the exhaust temperature sensors T3 arranged in the exhaust pipes 71, and in the case of 16 cylinders, sixteen exhaust pipes ranging from T3(1) to T3(16) are arranged for the cylinders, respectively.

Status variables acquired by the respective sensors included in the sensor group 22 (see FIG. 2) for detecting the operation status of the intake/exhaust system of the engine 11, specifically sensor data of the intercooler inlet temperature detected by the intercooler inlet temperature sensor T1, the intercooler inlet pressure detected by the intercooler inlet pressure sensor P1, the intercooler outlet temperature detected by the intercooler outlet temperature sensor T2, the intercooler outlet pressure detected by the intercooler outlet pressure sensor P2, and the exhaust temperatures detected by the exhaust temperature sensors T3(1)-T3(16) are inputted to the engine monitoring unit 13. The engine monitoring unit 13 then transmits the thus-inputted sensor data as sensing data, which relate to the intake/exhaust system of the engine 11, to the onboard terminal 100 via the network line.

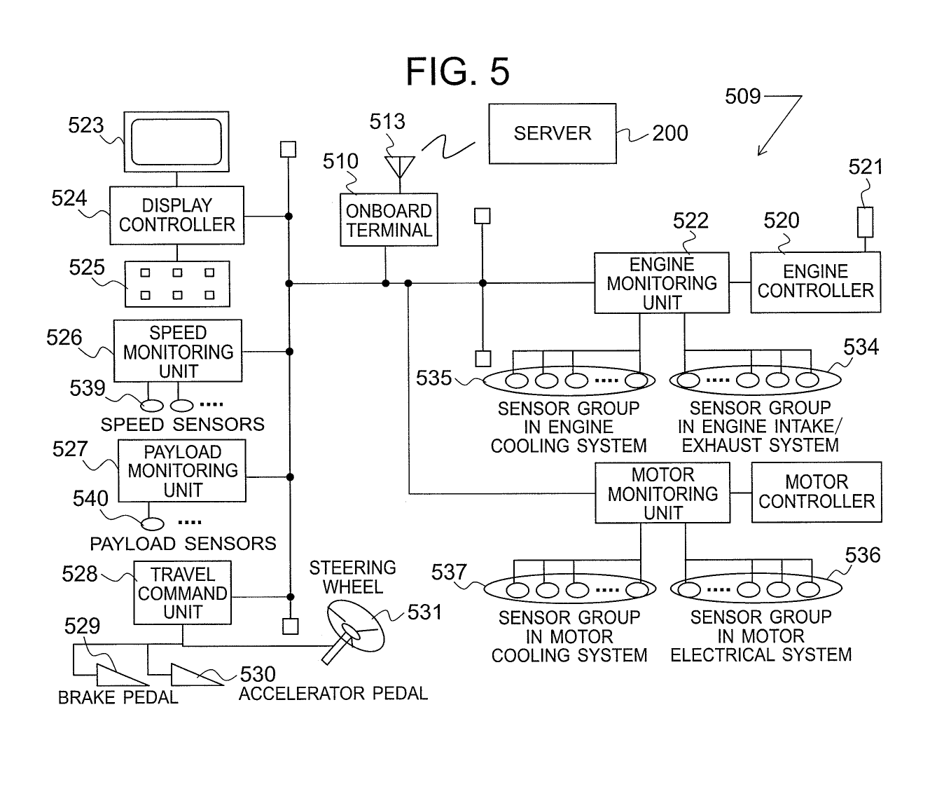

Referring to FIG. 5, a description will next be made of a configuration example of the controller network 509 of each dump truck 1B. As illustrated in FIG. 5, the controller network 509 is composed of an engine controller 520, an injection quantity controller 521, an engine monitoring unit 522, a motor controller 532, a motor monitoring unit 533, a brake pedal 529, an accelerator pedal 530, a steering wheel 531, a travel command unit 528 for outputting a travel command according to manipulation strokes of these brake pedal 529 and accelerator pedal 530 and a steering angle of the steering wheel 531, a display 523, a display controller 524, a keypad 525, a speed monitoring unit 526, a payload monitoring unit 527, and the onboard terminal 510.

The engine controller 520 is a device that controls the injection quantity controller 521 to govern the quantity of fuel to be injected into an engine (not shown). The engine monitoring unit 522 acquires, from various sensors, status variables relating to an operation status of the engine, and performs monitoring. As examples of the sensors for detecting the operation status of the engine, a sensor group 534 for sensing an operation status of an intake/exhaust system of the engine and a sensor group 535 for sensing an operation status of a cooling system of the engine are connected to the engine monitoring unit 522. It is to be noted that the configurations of the respective sensor groups 534,535 are substantially the same as those of the above-described sensor groups 20,22 in the excavator 1B.

The engine controller 520 and the engine monitoring unit 522 are connected via a communication line, and the engine monitoring unit 522 and the onboard terminal 510 are connected via a network line. By taking such a configuration, status variables relating to operation statuses of the intake/exhaust system and cooling system of the engine as detected by the various sensors can be transmitted to the onboard terminal 510.

Similarly, the motor controller 532 is a device that controls the rotational speed and direction of a motor. It is to be noted that the dump truck 1B is configured to enable traveling by driving a generator with power of the engine and rotating the motor with electric power outputted from the generator. The motor monitoring unit 533 performs monitoring by acquiring, from various sensors, status variables relating to an operation status of the motor. As examples of the sensors for detecting the operation status of the motor, a sensor group 536 for sensing an operation status of an electric system of the motor and a sensor group 537 for sensing an operation status of a cooling system of the motor are connected to the motor monitoring unit 533.

The display 523 is arranged in the operator's cab 504, and displays various operation information of the dump truck 1B. The display controller 524 is connected to the display 523, and controls displaying. The keypad 525 is connected to the display controller 524, and serves to perform setting of various data, screen switching of the display 523, and the like by manipulated inputs from an operator.

The speed monitoring unit 526 is a device that performs monitoring of status variables relating to the operation status of the dump truck 1B. To the speed monitoring unit 526, speed sensors 539 are connected. The payload monitoring unit 527 is a device that performs monitoring of status variables relating to the payload of the load body 503. To the payload monitoring unit 527, payload sensors 540 are connected. It is to be noted that the speed monitoring unit 526 and payload monitoring unit 527 are connected to the onboard terminal 510 via a network line.

The onboard terminal 510 is connected, via the network line, to the engine monitoring unit 522, motor monitoring unit 533, speed monitoring unit 526 and payload monitoring unit 527, and performs diagnostic processing on the operation status by a comparison between various sensor data transmitted from the respective units 522,533,526,527 and the corresponding normal reference values for each diagnostic item, the onboard terminal 100 performs diagnostic processing on the operation status.

The onboard terminal 510 is also connected to the display controller 524 via the network line, and may be configured to transmit diagnostic results to display them on the display 523. The onboard terminal 510 is also connected to the antenna 513 through which external communication can be performed. By being connected to the external server 200 and performing communication, the onboard terminal 510 can perform the transmission and reception of operation data, diagnostic results, diagnostic conditions and the like.

About the details of the diagnostic processing system 300, a description will next be made taking, as an example, a diagnostic processing system configured between the onboard terminal 100 of each excavator 1A and the server 200. It is to be noted that, although a diagnostic processing system configured between the onboard terminal 510 of each dump truck 1B and the server 200 is different in sensor data to be handled, diagnostic conditions, diagnostic items and the like in comparison with the diagnostic processing system configured between the onboard terminal 100 of each excavator 1A and the server 200, they are substantially the same in overall configuration and control method, and therefore, the description of the diagnostic processing system configured between the onboard terminal 510 of the dump truck 1B and the server 200 is omitted herein.

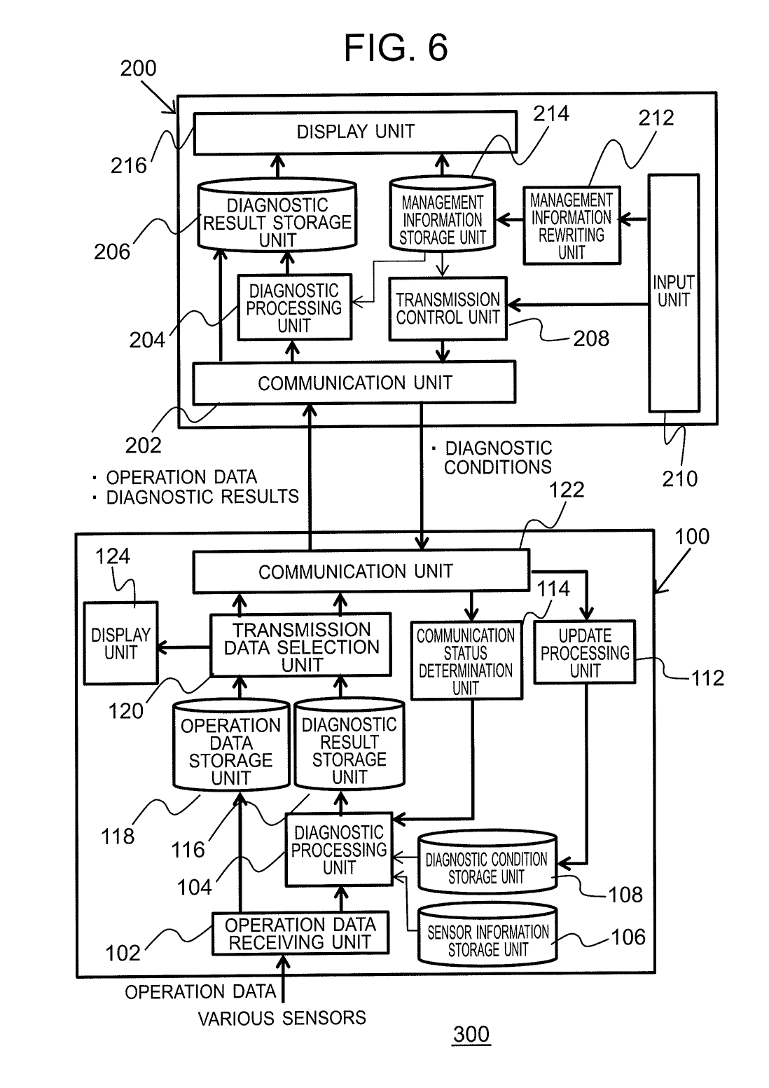

The electrical configuration of the diagnostic processing system 300 is depicted in FIG. 6. As depicted in FIG. 6, the diagnostic processing system 300 is generally composed of the onboard terminal 100 and the server 200. It is to be noted that the onboard terminal 100 is mounted on the excavator 1A as described above. One onboard terminal 100 is mounted on each excavator 1A. The server 200, on the other hand, is a system that controls plural onboard terminals 100, and a single server 200 is allocated to as many as N sets of onboard terminals 100.

The server 200 is composed of a communication unit (second communication unit) 202, a diagnostic processing unit (second diagnostic unit) 204, a diagnostic result storage unit 206, a transmission control unit 208, an input unit 210, a management information rewriting unit 212, a management information storage unit 214, and a display unit 216.

The communication unit 202 is a communication module for performing transmission and reception of data with each onboard terminal 100, and performs delivery and reception of data through communication with N sets of onboard terminals 100. The input unit 210 corresponds to a keyboard and mouse in a general personal computer, and performs rewriting or the like of information and diagnostic conditions controlled by the server. The display unit 216 corresponds to a display in a general personal computer, and outputs and displays diagnostic results and management information.

Based on operation data of the excavator 1A as transmitted from the onboard terminal 100, the diagnostic processing unit 204 performs diagnostic processing to detect an abnormality. The diagnostic result storage unit 206 holds and stores the result of a diagnosis performed at the onboard terminal 100 and the result of a diagnosis performed at the diagnostic processing unit 204 of the server 200. The management information storage unit 214 stores management information, such as diagnostic conditions and diagnostic items, relating to the performance of diagnoses at the onboard terminal 100 and server 200. Based on command information received via the input unit 210, the management information rewriting unit 212 rewrites the information in the management information storage unit 214. Based on command information received via the input unit 210, the transmission control unit 208 transmits the information stored in the management information storage unit 214, such as the diagnostic conditions, to the onboard terminal 100 via the communication unit 202.

The onboard terminal 100, on the other hand, is composed of an operation data receiving unit (data receiving unit) 102, a diagnostic processing unit (first diagnostic unit) 104, a sensor information storage unit 106, a diagnostic condition storage unit 108, an update processing unit 112, a communication status determination unit 114, a diagnostic result storage unit 116, an operation data storage unit 118, a transmission data selection unit 120, a communication unit 122, and a display unit 124.

The operation data receiving unit 102 is connected to the engine monitoring unit 13 and hydraulic pressure monitoring unit 23 via the network line (see FIG. 2), and receives operation data of various sensors as status variables of each part/system. Using, as inputs, the operation data received at the operation data receiving unit 102, the diagnostic processing unit 104 performs diagnostic processing for diagnosing the operation status of the excavator 1A. The operation data storage unit 118 stores the operation data received at the operation data receiving unit 102. The diagnostic result storage unit 116 stores the result of processing performed at the diagnostic processing unit 104.

With reference to the information in the operation data storage unit 118 and diagnostic result storage unit 116, the transmission data selection unit 120 creates transmission data to be transmitted to the server 200 and outputs them to the communication unit 122, and also, performs information display output control to the display unit 124 as needed. The communication unit 122 is a communication module that performs transmission and reception of data with the server 200. The update processing unit 122 is inputted with information relating to the diagnostic conditions as received from the server 200 via the communication unit 122, and performs processing to rewrite the contents of the diagnostic condition storage unit 108.

The communication status determination unit 114 receives, from the communication unit 122, information indicating a state of communication establishment between the onboard terminal 100 and the server 200 (for example, the number of responses or the reception or non-reception of a response from the server to requests or a request outputted to the server), and outputs, to the diagnostic processing unit 104, information on a communication state (communication status) (for example, good communication, unstable communication, out of communication range, or the like) determined based on the first-mentioned information. The diagnostic condition storage unit 108 stores processing conditions under which the diagnostic processing unit 104 is to perform processing. The sensor information storage unit 106 stores identification-related information for recognizing the status of which part or system the operation data of the excavator 1A, which have been received at the operation data receiving unit 102, indicate.

A description will next be made in detail about the contents of processing to be performed at the onboard terminal 100. The operation data receiving unit 102 will be described first. The operation data receiving unit 102 is connected to the engine monitoring unit 13 and hydraulic pressure monitoring unit 23 via the network line (see FIG. 2), and receives operation data of various sensors as status variables of the respective parts/systems.

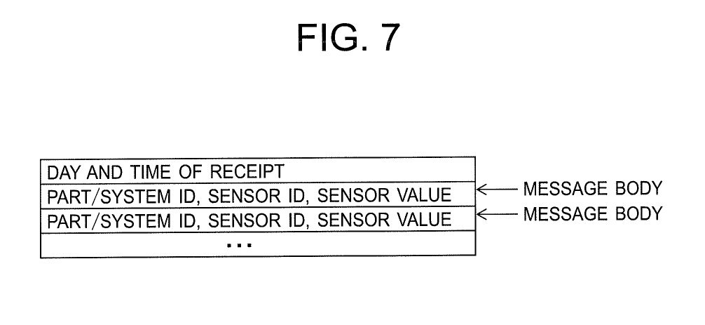

FIG. 7 illustrates a configuration example of operation data to be received from the excavator 1A. The operation data is composed, for example, of message bodies each of which consists, as a single unitary combination, of a part/system ID, a sensor ID and a sensor value, and the day and time of receipt of the message bodies as clocked by an internal clock (not shown) of the onboard terminal 100.

It is to be noted that the term “part/system ID” as used herein means an ID for specifying the part or system where a target sensor is arranged and the term “sensor ID” means a unique ID for uniquely specifying the target sensor out of sensors arranged at the target part or system. The term “sensor value” indicates a measurement value by the unique sensor specified by the part/system ID and sensor ID.

Upon receipt of the operation data illustrated in FIG. 7, the operation data receiving unit 102 first performs processing to output and store the operation data to and in the operation data storage unit 118. Accordingly, the information that the operation data illustrated in FIG. 7 have been accumulated in the time direction (in the chronological order) is stored in the operation data storage unit 118. The operation data receiving unit 102 also performs processing to output the thus-received operation data to the diagnostic processing unit 104.

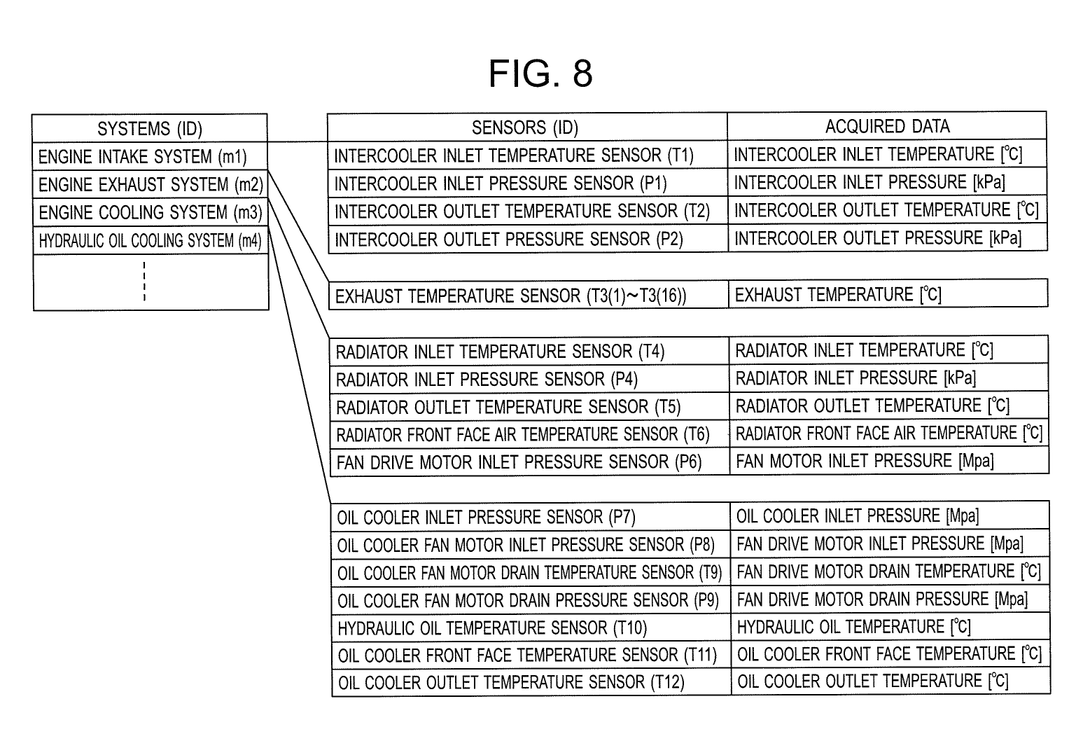

Using FIG. 8, a description will next be made about the contents stored in the sensor information storage unit 106. As illustrated in FIG. 8, the sensor information storage unit 106 stores information for identifying part/system IDs and sensor IDs contained in the operation data received from the excavator 1A. In other words, the sensor information storage unit 106 stores detailed information and identification information on the sensors, which are specified by the combinations of the part/system IDs and sensor IDs. The diagnostic processing unit 104 can recognize the contents of the operation data by referring to the contents of the sensor information storage unit 106.

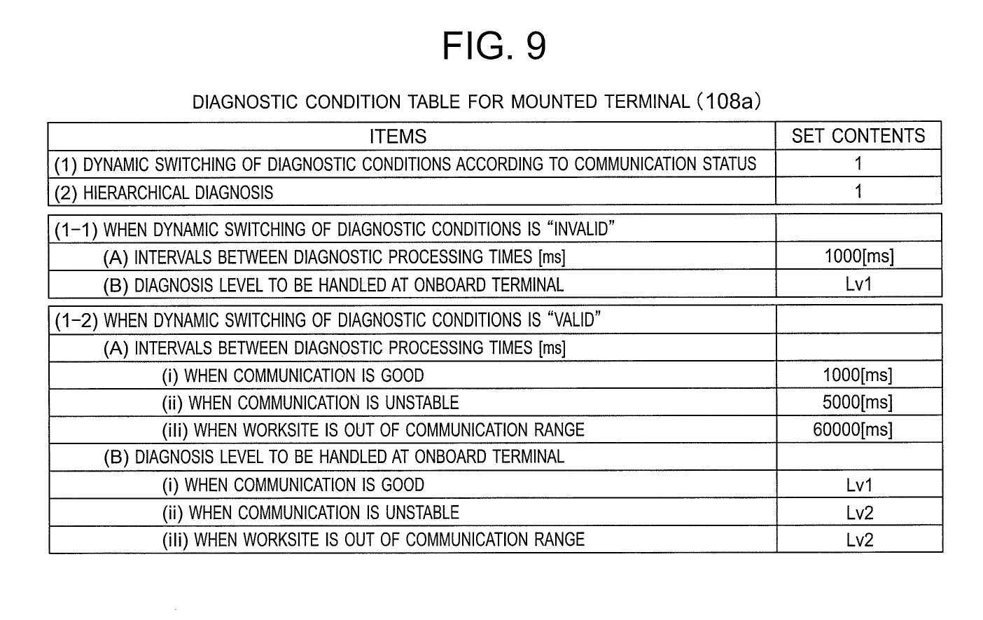

Using FIG. 9 to FIG. 11, a description will next be made in detail about the contents of the diagnostic condition storage unit 108. In the diagnostic condition storage unit 108, a diagnostic condition table 108a for onboard terminal, a diagnostic item table 108b, and a diagnostic model table 108c are stored. Using FIG. 9, a description will first be made about the diagnostic condition table 108a for onboard terminal, which is stored in the diagnostic condition storage unit 108. As illustrated in FIG. 9, conditions for diagnostic processing to be performed on the side of each onboard terminal 100 are set in the diagnostic condition table 108a for onboard terminal.

Item (1) of FIG. 9 specifies, as diagnostic conditions, whether or not the diagnostic conditions are dynamically switched according to the communication status with the server 200. It is to be noted that in the column labeled “set contents”, “1” indicates valid setting while “0” indicates invalid setting. When “1” is set, a dynamic change is made according to the communication status with the server 200 as detected by the communication status determination unit 114 when the diagnostic processing unit 104 performs diagnostic processing. In other words, using each change in communication status as a trigger, the diagnostic conditions are changed as needed. Specific diagnostic conditions when the setting is valid are set in item (1-2) of FIG. 9. When “0” is set in item (1) of FIG. 9, on the other hand, the diagnostic processing unit 104 performs processing under the fixed diagnostic conditions irrespective of the communication status with the server 200. The specific diagnostic conditions when the setting is invalid are set in item (1-1) of FIG. 9.

Matters to be set in item (1-1) and item (1-2) of FIG. 9 are (A) the intervals between diagnostic processing times and (B) the diagnosis level to be handled at the onboard terminal 100. The term “intervals between diagnostic processing times (A)” means the intervals between processing times at each of which the diagnostic processing unit 104 performs abnormality determination processing on operation data. In (A) of item (1-1), the intervals between diagnostic processing times are set at 1,000 ms irrespective of the communication status with the server 200. In (A) of item (1-2), on the other hand, the intervals between diagnostic processing times are selectively set, for the dynamic switching of the diagnostic condition, at one of three levels depending on when the communication status with the server 200 is (i) good, (ii) unstable or (iii) out of communication range.

In the example of FIG. 9, the intervals between diagnostic processing times are set at 1,000 ms in the case (i), 5,000 ms in the case (ii) or 60,000 ms in the case (iii), namely such that the intervals between diagnostic processing times become longer as the communication status deteriorates, because in a poor communication status, shortening of the intervals between diagnostic processing times requires the onboard terminal 100 to perform up to the diagnosis of Lv2 and results in an increased processing load on the onboard terminal 100.

Further, the term “diagnosis level” in (B) means to which one of the plural diagnosis levels (specifically, Lv1 and Lv2) set in the below-described diagnostic item table 108b the diagnostic processing is handled on the side of the onboard terminal 100. In (B) of item (1-1), the diagnosis level to be handled at the onboard terminal 100 is set at Lv1 irrespective of the communication status with the server 200. In (B) of item (1-2), on the other hand, the diagnosis level is set according to the communication status with the server 200 to dynamically switch the diagnostic condition. Described specifically, the diagnosis level to be handled by the onboard terminal 100 is set at Lv1 in the case of (i) good communication or at Lv2 in the case of (ii) unstable communication or in the case of (iii) out of communication range. Described specifically, in this embodiment, the onboard terminal 100 performs only diagnoses of up to Lv1 when the dynamic switching of the diagnostic condition is valid and the communication status is good, but the onboard terminal 100 performs diagnoses of up to Lv2 when it is difficult or impossible to transmit data from the onboard terminal 100 to the side of the server 200.

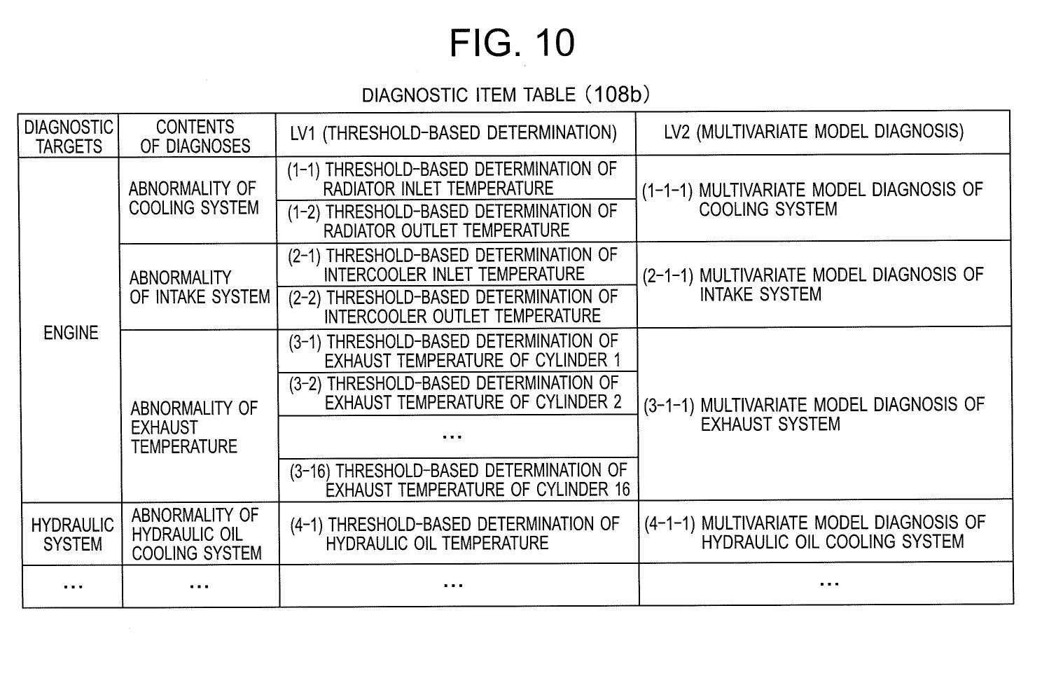

Next, item (2) of FIG. 9 specifies, as a diagnostic condition, whether a hierarchical diagnosis is valid or invalid. The term “hierarchical diagnosis” as used herein means to perform diagnostic processing by changing the diagnosis level stepwise from a simple diagnosis to a detailed diagnosis. Specifically describing based on the below-described diagnostic item table 108b (see FIG. 10), the term “hierarchical diagnosis” means first to perform diagnostic processing (a simple diagnosis) at the diagnosis level Lv1 ranked as a simple diagnosis level, and then to perform diagnostic processing (a detailed diagnosis) at the diagnosis level Lv2 ranked as a more detailed diagnosis level.

When the setting of item (2) of FIG. 9 is “1”, that is, valid setting, diagnoses are performed stepwise upon receipt of the diagnostic result of each superordinate item such that the diagnosis of each subordinate item is performed only when the diagnostic result of its superordinate item is “abnormal”. When the setting of item (2) is “0”, that is, invalid setting, on the other hand, all the levels are taken as equivalent to each other and the diagnosis of each subordinate item is also performed irrespective of the diagnostic result of its superordinate item. The details of the foregoing will be described specifically upon description of a flow of processing at the diagnostic processing unit 104.

Using FIG. 10, a description will next be made about the diagnostic item table 108b stored in the diagnostic condition storage unit 108. The diagnostic item table 108b illustrated in FIG. 10 is a table that controls diagnostic items for performing diagnostic processing at the diagnostic processing unit 104. The diagnostic item table 108b controls the content of each diagnosis (diagnostic item) for every system at a diagnostic part. For example, the systems at the diagnostic part of the engine in FIG. 10 have three major diagnostic items, that is, an abnormality of the cooling system, an abnormality of the intake system, and an abnormality of the exhaust temperature. Of these, the abnormality of, for example, the cooling system requires two determinations of (1-1) the threshold-based determination of the radiator inlet temperature and (1-2) threshold-based determination of radiator outlet temperature as diagnostic items of Lv1 (primary diagnosis) and one diagnosis of (1-1) the multivariate model diagnosis of cooling system as a diagnostic item of Lv2 (secondary diagnosis).

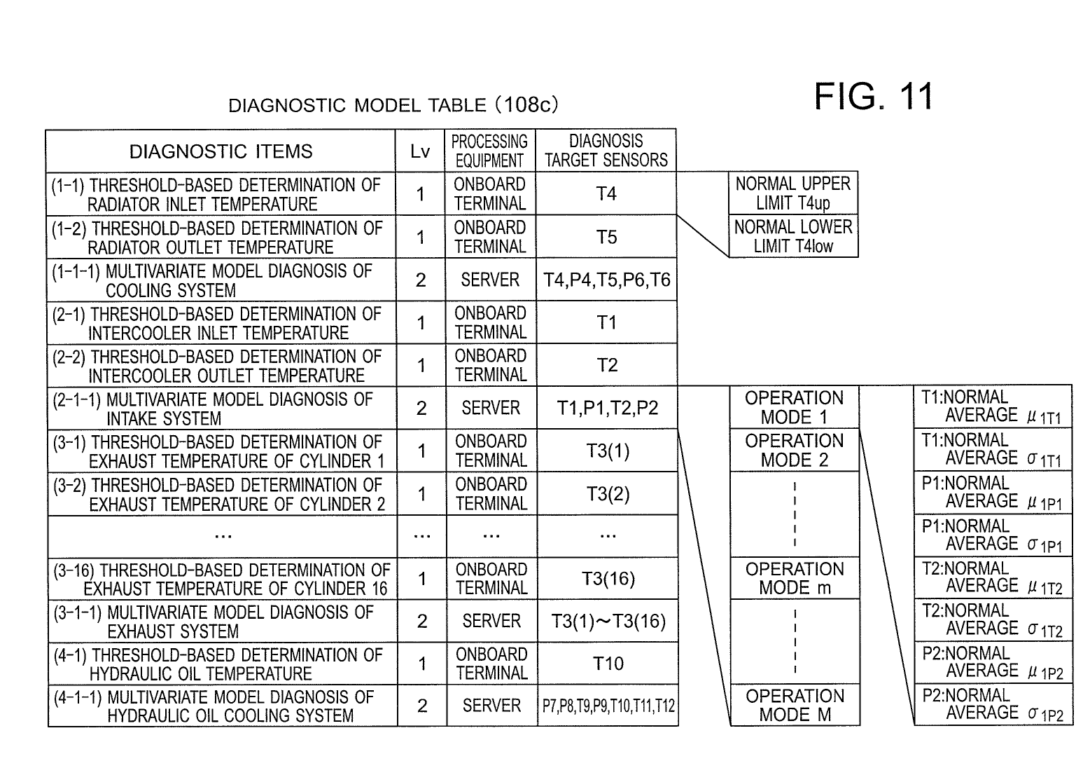

The diagnostic items of Lv1 are each diagnosed by a threshold-based determination that the data of the relevant sensor is compared with the corresponding normal value stored in the diagnostic model table 108c (see FIG. 11), and in this embodiment, are ranked as simple diagnostic items. The diagnostic item of Lv2, on the other hand, requires to perform a more complex and detailed diagnosis than Lv1, and therefore, is diagnosed by subjecting the data of plural relevant sensors to a multivariate analysis, and the determination of an abnormality is conducted by a comparison between the normal reference values of the plural sensors as stored in the diagnostic model table 108c illustrated in FIG. 11 and the results of the multivariate analysis. In the above-described example, the diagnosis levels are differentiated by the difference in diagnostic method, that is, by the threshold-based determination and the multivariate model diagnosis. However, it is possible, for example, to differentiate the diagnosis level by a difference in relevant sensor despite the use of the same diagnostic method (the same content of processing). It is also possible to have a configuration that has more diagnosis levels, for example, Lv3, Lv4, . . . in addition to Lv1 and Lv2.

Using FIG. 11, a description will next be made about the diagnostic model table 108c stored in the diagnostic condition storage unit 108. The diagnostic model table 108c illustrated in FIG. 11 is a table in which parameters upon performance of the respective diagnostic items illustrated in FIG. 10 by the diagnostic processing unit 104 are summarized. For example, the diagnostic model table 108c stores, with respect to each diagnostic item, a diagnosis level, a place for handling diagnostic processing (processing place), a sensor as a diagnosis target, and normal reference values (upper limit, lower limit, average, variance, and the like) for use in the diagnosis.

The diagnostic level for each diagnostic item corresponds to the corresponding Lv in the diagnostic item table 108b of FIG. 10. As the place that is handle each diagnostic processing, it is basically set that the onboard terminal 100 handles each superordinate item (Lv1) and the server 200 handles each subordinate item (Lv2). As mentioned above, even when the processing place is set to be the server 200, the processing place may, of course, be dynamically changed from the server 200 to the onboard terminal 100 depending on the communication status between the onboard terminal 100 and the server 200.

Concerning a sensor or sensors as a diagnosis target or diagnosis targets, a single sensor becomes a target in the case of Lv1 because threshold-based determination is performed, but plural sensors become targets in the case of Lv2 because a multivariate diagnosis is performed. With respect to each item of Lv1, normal upper limit and normal lower limit for performing threshold-based determination are stored as normal reference values. As to each item of Lv2, on the other hand, normal average and normal variance relating to plural sensors, said normal average and normal variance being for performing a multivariate diagnosis, are stored as normal reference values. However, these normal average and normal variance are, therefore, set separately for each operation mode because they differ in characteristics from one operation mode to another. It is to be noted that the term “operation mode” means, for example, an operation manner such as swinging of the upperstructure 3, raising of the boom 6, or traveling of the excavator 1A.

As described above, the diagnostic condition table 108a for onboard terminal, the diagnostic item table 108b and the diagnostic model table 108c are stored in the diagnostic condition storage unit 108, and the diagnostic processing unit 104 primarily performs diagnostic processing with reference to these tables. Further, the update processing unit 112 can rewrite the set contents of the respective tables 108a, 108b, 108c, which are stored in the diagnostic condition storage unit 108, to the contents received from the server 200.

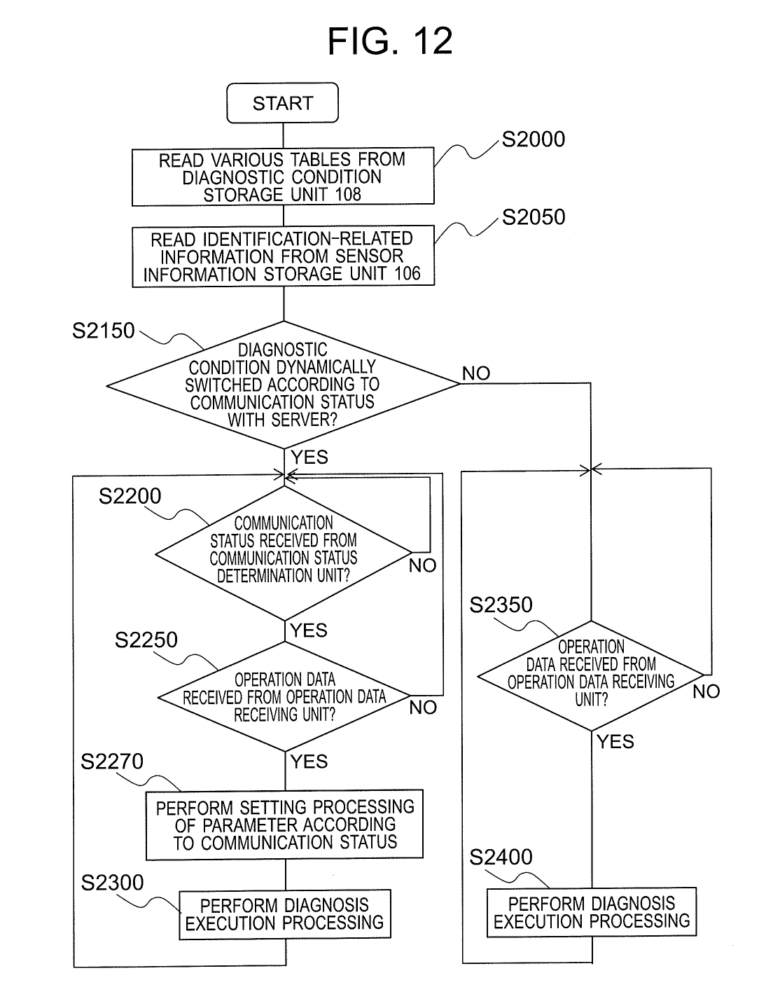

Using FIG. 12, a description will next be made in detail about the contents of diagnostic processing to be performed by the diagnostic processing unit 104. FIG. 12 is a flow chart illustrating the procedure of the diagnostic processing at the diagnostic processing unit 104. As illustrated in FIG. 12, when the onboard terminal 100 is started, the diagnostic processing unit 104 first reads, in S2000, the above-described various tables, specifically the diagnostic condition table 108a for onboard terminal, the diagnostic item table 108b and the diagnostic model table 108c from the diagnostic condition storage unit 108. In S2050, the diagnostic processing unit 104 then reads the identification-related information stored in the sensor information storage unit 106.

In S2150, the diagnostic processing unit 104 then recognizes, from the contents of the diagnostic condition table 108a for onboard terminal as illustrated in FIG. 9 and as read in S2000 described above, the set content as to the dynamic switching of the diagnostic conditions according to the communication status in item (1), and determines to be YES when the set content is “1” or determines to be NO when the set content is “0”. When a determination of NO is made in step S2150, the diagnostic processing unit 104 determines in step 2350 whether or not new operation data has been received from the operation data receiving unit 102. When no new operation data has been received, a determination of NO is made, and the determination processing of S2350 is repeated until new operation data is received. When new operation data has been received, on the other hand, a determination of YES is made in S2350, and the diagnostic processing unit 104 performs diagnosis execution processing in S2400. About the details of this diagnosis execution processing in S2400, a description will be separately made subsequently herein.

The control flow returns to S2150. When a determination of YES is made in this step, the control flow proceeds to the step of S2200. In S2200, the diagnostic processing unit 104 determines whether or not information on the communication status with the server 200 has been received from the communication status determination unit 114. When the information has not been received yet here, the diagnostic processing unit 104 determines to be NO, and the determination processing is repeated until the information is received. When determined to be YES, on the other hand, the control flow proceeds to S2250, where the diagnostic processing unit 104 determines whether or not new operation data has been received from the operation data receiving unit 102. When the diagnostic processing unit 104 determines in S2250 that no new operation data has been received, the control flow returns to S2200. After a change in the communication status with the server 200 has been newly confirmed in S2200, a determination is made again in S2250 as to whether or not operation data has been received from the operation data receiving unit 102. When new operation data is determined to have been received from the operation data receiving unit 102 in S2250, the diagnostic processing unit 104 performs in S2270 the setting processing of parameters according to the communication status.

In S2270, the diagnostic processing unit 104 performs the setting processing of parameters according to the communication status, which has been received from the communication status determination unit 114 in S2200 described above, based on the contents of the diagnostic condition table 108a for onboard terminal as illustrated in FIG. 9. Described specifically, the diagnostic processing unit 104 determines and sets, based on which one of “good communication”, “unstable communication” and “worksite is out of communication range” has been received from the communication status determination unit 114 as to the communication status with the server 200, the two parameters of (A) the intervals between diagnostic processing times and (B) the diagnosis level to be handled at the onboard terminal in item (1-2) of FIG. 9. After completion of this setting processing, the diagnostic processing unit 104 performs diagnostic execution processing in S2300.

Although the processing of this S2300 will be described subsequently herein, the same processing as the diagnostic execution processing in S2400 is performed basically. Differences between S2300 and S2400 reside in the content of the set parameter and also in whether or not there is a change in the content. Described specifically, concerning S2300, processing is performed in S2300 to change the set content of the parameter when there is a change in the communication status. In S2400, on the other hand, the parameter in the case of “no” change in the communication status in item (1-1) of the diagnostic condition table 108a for onboard terminal is used in the processing, and no processing is performed to change the set content of the parameter even if there is a change in the communication status.

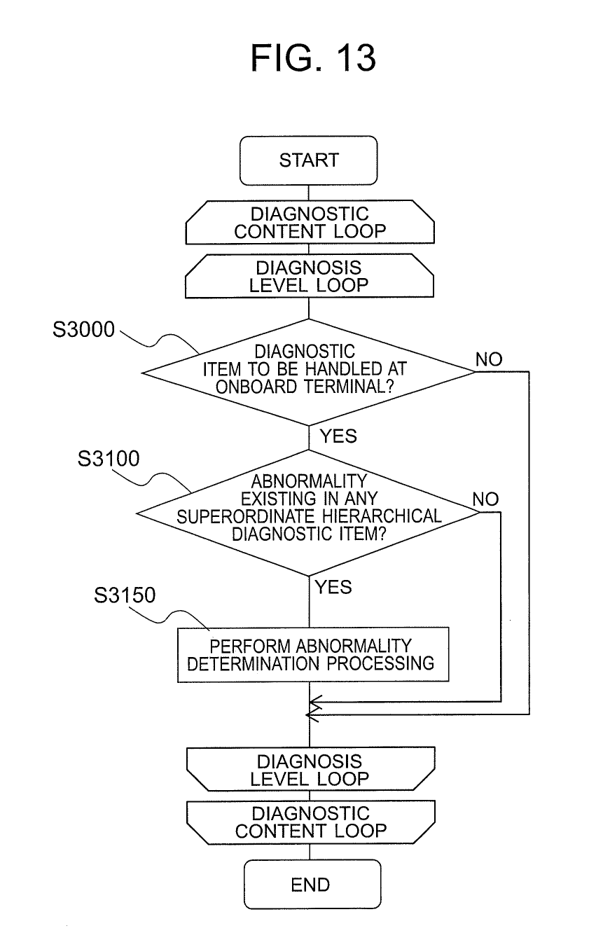

Using FIG. 13, a description will next be made in detail about the contents of the diagnostic execution processing performed by the diagnostic processing unit 104 in S2300 and S2400. FIG. 13 is a flow chart illustrating the procedure of the diagnostic execution processing. The contents of the diagnostic execution processing illustrated in FIG. 13 show the processing when the setting of (2) hierarchical diagnosis in the diagnostic condition table for onboard terminal as illustrated in FIG. 9 is valid. When this setting is invalid, on the other hand, the processing procedure does not include the determination processing of S3100 in FIG. 13. The following is a description about the case that the setting of hierarchical diagnosis is valid.

In the diagnostic execution processing, the diagnostic processing unit 104 performs the processing of S3000 to S3150 for each diagnostic content and each diagnosis level. The expression “each diagnostic content” means each “diagnostic content” in the diagnostic item table 108b illustrated in FIG. 10, and means to perform a diagnosis, for example, for each of an abnormality of the cooling system, an abnormality of the intake system, and an abnormality of exhaust temperature. Further, the expression “each diagnosis level” means to perform processing at the diagnosis level of each of Lv1 and Lv2 in the diagnostic item table 108b illustrated in FIG. 10.

In S3000, the diagnostic processing unit 104 determines, with respect to a diagnostic item of a given diagnostic content and a given diagnosis level, whether or not the diagnosis of the diagnostic item is to be handled at the onboard terminal 100. Described in more detail, in the determination processing in S3000, the diagnostic processing unit 104 determines, with reference to the contents of the diagnostic model table 108c of FIG. 11, whether or not the processing place for the diagnostic item has been set to be “onboard terminal”. In addition, the diagnostic processing unit 104 also confirms in S3000 whether or not the parameter (the parameter of the diagnosis level handled at the onboard terminal 100) set in S2270 of FIG. 12 exists.

Here, when the parameter set in S2270 of FIG. 12 exists, the thus-set parameter is supposed to be used preferentially, and the diagnostic processing unit 104 determines whether or not the processing place for the diagnostic item is the onboard terminal 100. When the parameter does not exist, the diagnostic processing unit 104 determines, based on the contents of the diagnostic model table 108c of FIG. 11, whether or not the processing place for the diagnostic item is the onboard terminal 100.

A description will now be made, for example, about an illustrative case of performing a diagnosis for any abnormality of the cooling system in the engine 11 (see FIG. 10). When the communication status is good and the setting of dynamic switching of the diagnostic conditions is valid “1” (see item (1) in FIG. 9), the parameter of the diagnosis level to be handled at the onboard terminal 100 is set at Lv1 (see item (1-2)-(B)-(i) in FIG. 9). In this case, the threshold-based determination of radiator inlet temperature (1-1) and the threshold-based determination of radiator outlet temperature (1-2) (see FIG. 11), the diagnosis levels of which are Lv1, are processed by the onboard terminal 100, and the multivariate model diagnosis of the cooling system (1-1-1), the diagnosis level for which is Lv2, is processed by the server 200.

When the communication status is unstable, on the other hand, the parameter of the diagnosis level to be handled at the onboard terminal 100 is set at Lv2 (see item (1-2)-(B)-(ii) in FIG. 9). In this case, the threshold-based determination of radiator inlet temperature (1-1) and the threshold-based determination of radiator outlet temperature (1-2) (see FIG. 11), the diagnosis levels of which are Lv1, are processed by the onboard terminal 100. Further, when an abnormality is determined by this processing (YES in S3100), the multivariate model diagnosis of the cooling system (1-1-1), the diagnosis level of which is Lv2, is also processed by the onboard terminal 100.

When the processing place for the diagnostic item is determined to be the onboard terminal 100 in S3000, the diagnostic processing unit 104 makes a determination of YES, and the control flow proceeds to S3100. When the processing place for the diagnostic item is determined to be the server 200, on the other hand, the diagnostic processing unit 104 makes a determination of NO, and the control flow proceeds to the processing of the next diagnostic content or diagnosis level.

When a determination of YES is made in S3000, the diagnostic processing unit 104 determines in S3100 whether or not any abnormality exists in any superordinate hierarchical diagnostic item. It is to be noted that the expression “superordinate hierarchical diagnostic item” means a diagnostic item of Lv1 relative to a diagnostic item of a given diagnostic content and of Lv2. Specifically describing by using the diagnostic item table 108b of FIG. 10, the diagnostic items superordinate in hierarchy to the multivariate model diagnosis of cooling system, which is a diagnostic item for an abnormality of the cooling system in the engine, are the threshold-based determination of radiator inlet temperature and the threshold-based determination of radiator outlet temperature.

When YES is determined in S3100, the control flow proceeds to S3150, where the diagnostic processing unit 104 performs abnormality determination processing. In other words, the processing that the control flow proceeds from S3100 to S3150 means to execute a diagnostic item of Lv2 only when an abnormality has occurred with respect to a diagnostic item of Lv1 on a given diagnostic content. This becomes the procedure of processing when the setting of hierarchical diagnosis as item (2) in the diagnostic condition table 108a for onboard terminal as illustrated in FIG. 9 is valid. When this setting is invalid, on the other hand, processing is performed at both the diagnosis levels at Lv1 and Lv2 irrespective of the diagnostic results of the superordinate hierarchical diagnostic items.

A description will next be made about the abnormality determination processing to be performed in S3150. The abnormality determination processing includes two major kinds of processing, which are threshold-based determination processing of Lv1 and multivariate model diagnostic processing of Lv2. The contents of the respective kinds of processing will hereinafter be described.

A description will first be made about the threshold-based determination processing of Lv1. Now assume that with respect to a diagnosis target sensor for a given diagnostic item, the sensor data at time t is d(t). Normal upper limit and normal lower limit, which are useful in a threshold-based determination of Lv1, are stored in the diagnostic model table 108c illustrated in FIG. 11. Representing these normal upper limit and normal lower limit by dᵤₚ and d_{low}, respectively, the diagnostic item is determined to be normal when d(t) satisfies the following equation (1), but is determined to be abnormal when d(t) does not satisfy the following equation (1).

d_{low}≦d(t)≦dᵤₚ (1)

A description will next be made about the multivariate model diagnostic processing of Lv2. In the multivariate model diagnostic processing of Lv2, N pieces of sensor data as diagnosis targets are represented by d₁(t), d₂(t), . . . , d_{N}(t), respectively. In the diagnostic model table 108c illustrated in FIG. 11, normal average and normal variance are stored for every operation mode. Now representing the normal average and normal variance of a sensor i in an operation mode m (m=1, 2, . . . , M) by μₘ₁ and σₘ₁, respectively, the degree of deviation L(t,m) in every operation mode is first calculated using the following equation (2) in the multivariate model diagnostic processing of Lv2.

$$L ( t , m ) = \sqrt{{\sum }_{i = 1}^{N} {( \frac{{d}_{i} ( t ) - {μ}_{m i}}{{σ}_{m i}} )}^{2}} \qquad ( 2 )$$

The operation mode m=m(Lₘᵢₙ) of the minimum degree of deviation out of the degrees of deviation L(t,m) of the M operation modes m(m=1, 2, . . . , M) is then newly specified as an operation mode in the target diagnostic item, and the degree of deviation at that time is adopted as a degree of deviation L(t) at the time t. This degree of deviation L(t) is a value obtained by calculating how much the sensor data as a diagnosis target deviates from the center of normal reference values, and is expressed in terms of a ratio to the normal variance. When the sensor data are presumed to be in normal distribution, the degree of deviation L(t) is determined to be abnormal when it is greater than 3, but is determined to be normal when it is smaller than 3.

It is also possible to calculate which sensor data contributes most to the degree of deviation L(t) among the N pieces of sensor data d₁(t), d₂(t), . . . , d_{N}(t) as diagnosis targets. With respect to a model composed of plural sensors, it is hence possible to specify the sensor that contributes most to an abnormality and to estimate the cause of the occurrence of the abnormality.

In S3150, the diagnostic processing unit 104 performs such abnormality determination processing of Lv1 and Lv2 as described above, and outputs the results to the diagnostic result storage unit 116. Here, the diagnostic processing unit 104 outputs, as contents to be written in the diagnostic result storage unit 116, at least the diagnostic item number indicating the diagnostic item, the diagnosis levels, the communication status at that time, and the diagnostic results indicating “abnormal” or “normal”.

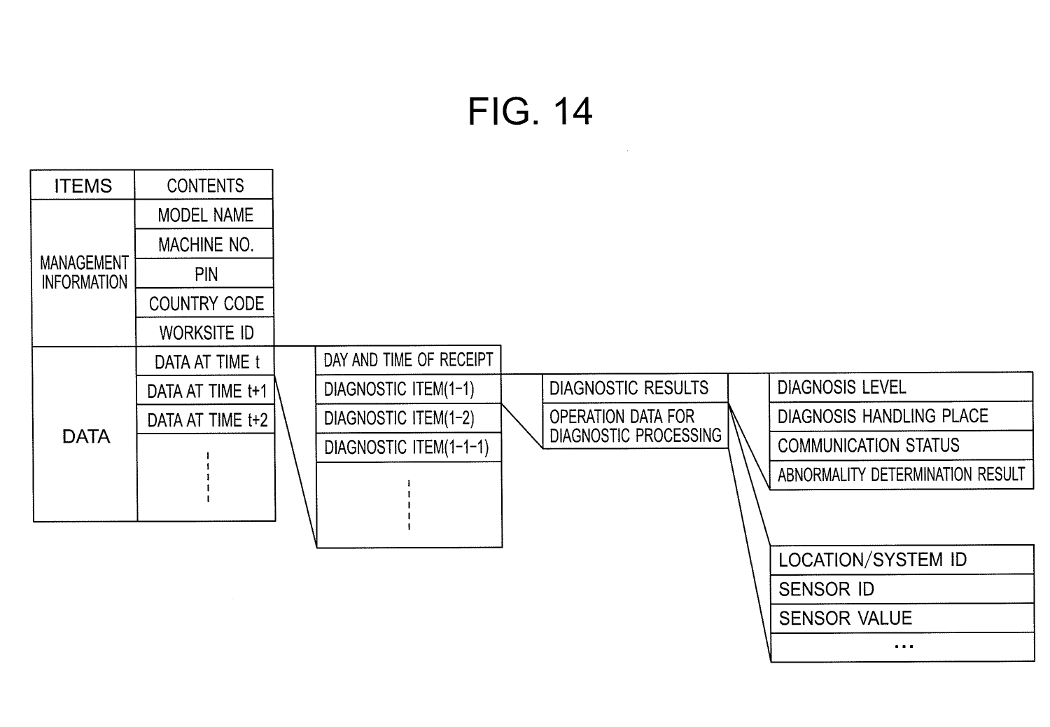

A description will next be made about the contents of processing at the transmission data selection unit 120 that produces data, which are to be transmitted to the server 200, with reference to the operation data storage unit 118 and diagnostic result storage unit 116. Based on the operation data acquired at the onboard terminal 100 and the results of diagnostic processing performed there, the transmission data selection unit 120 performs processing to produce the data to be transmitted to the server. An illustrative format of the data, which are produced by the transmission data selection unit 120 and are to be transmitted to the server, are illustrated in FIG. 14. As illustrated in FIG. 14, large areas labeled “management information” and “data” exist in the data to be transmitted to the server.

Included in the management information are the model name and machine number, PIN, country code and site ID of the excavator 1A as a target. The model name, machine number and PIN are information that can uniquely specify the excavator 1A, and based on this information, the server determines to which machine the data relate. The country code is information that specifies the country where the excavator 1A is operating. The site ID is information for specifying the worksite where the excavator 1A is operating.

In the area labeled “data”, on the other hand, regions are reserved to store diagnostic results and operation data for diagnostic processing by time and diagnostic item. In each data field labeled “diagnostic results”, subfields are reserved to record a diagnosis level, a diagnosis handling place, a communication status, and an abnormality determination result, respectively. In the subfield labeled “diagnosis level”, the diagnosis level to which the target diagnostic item belongs is recorded. In the subfield labeled “diagnosis handling place”, the place where the target diagnostic item is to be processed is recorded. Described specifically, the keyword of the onboard terminal 100 is reflected to the subfield labeled “diagnosis handling place” when diagnosed by the onboard terminal 100, but the keyword of the server 200 is reflected there when no diagnosis has been performed yet.

In the subfield labeled “communication status”, one of “good communication”, “unstable communication” and “out of communication” is recorded as a keyword that indicates the communication status with the server 200 at the relevant day and time. “NULL” is, however, recorded when the communication status is unknown. To the subfield labeled “abnormal determination result”, the result of the diagnosis by the diagnostic processing unit 104 is reflected, and the keyword of either “abnormal” or “normal” is reflected. “NULL” is, however, reflected to this subfield when the diagnosis handling place is the server 200 and no diagnostic result has been obtained yet.

In the field labeled “operation data for diagnostic processing”, on the other hand, information on sensor data used as a diagnostic target or to be used as a diagnostic target for the diagnostic item is recorded. Described more specifically, a part/system ID, a sensor ID and a sensor value are recorded as information on sensor data. The information to be recorded is operation data closest to the day and time of receipt. Further, concerning each diagnostic item that in the field labeled “diagnosis results”, the keyword of the server 200 is recorded in the subfield labeled “diagnosis handling place” and that no diagnosis has been performed yet, diagnostic processing will be performed on the side of the server 200 upon input of information on the operation data for diagnostic processing.

The transmission data selection unit 120 creates data, which are to be transmitted to the server, with such contents as described above, and transmits them to the server 200 via the communication unit 122.

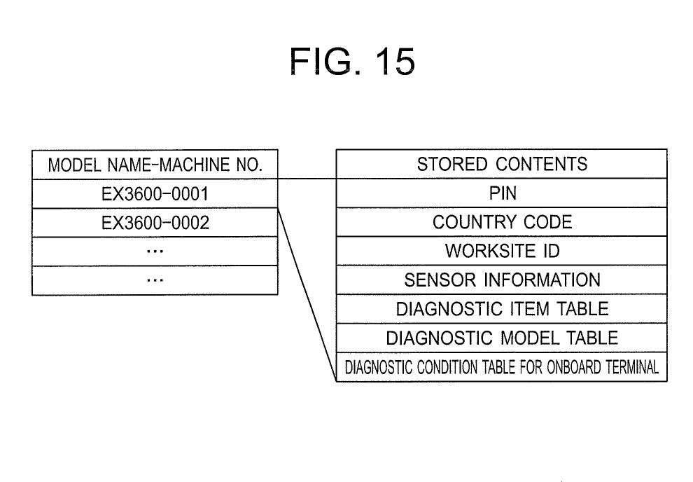

A description will next be made in detail about the contents of processing to be performed at the server 200. The contents of the management information storage unit 214 of the server 200 will be described first with reference to FIG. 15. As illustrated in FIG. 15, the management information storage unit 214 stores management information for every excavator 1A as a target of management. In this embodiment, as IDs that specify the excavator 1A, its model name and machine number are used. The model name is information for specifying the type of the excavator 1A, and a unique machine number is applied to each model. Each working machine can, therefore, be uniquely specified by its model name and machine number.

In the management information storage unit 214, for each combination of model name and machine number, the corresponding PIN, country code, site ID, sensor information, diagnostic item table, diagnostic model table, and diagnostic condition table for onboard terminal are stored. PIN is unique ID information applied by a maker, and unique ID information on each machine. Country code is an ID for specifying the country where the target excavator 1A is operating. Site ID is an ID for specifying the mine site where the excavator 1A is operating.

The diagnostic item table, diagnostic model table, and diagnostic condition table for onboard terminal, which are stored in the management information storage unit 214, contain the same information as those in the diagnostic condition storage unit 108 of the onboard terminal 100. Described specifically, the contents of the various tables stored in the management information storage unit 214 are rewritable by the management information rewriting unit 212 according to a command from the input unit 210, and by a command from the input unit 210, the contents so rewritten are transmitted to the side of the onboard terminal 100 via the transmission control unit 208 and communication unit 202. At the onboard terminal 100, on the other hand, the information of the various tables received from the server 200 via the communication unit 122 is written in the diagnostic condition storage unit 108 by the update processing unit 112 to perform update processing.

Accordingly, the diagnostic item table, diagnostic model table and diagnostic condition table for onboard terminal, which are stored in the management information storage unit 214, have the same contents as the tables 108a,108b,108c illustrated in FIGS. 9 to 11 and stored in the diagnostic condition storage unit 108 of the onboard terminal 100, respectively.

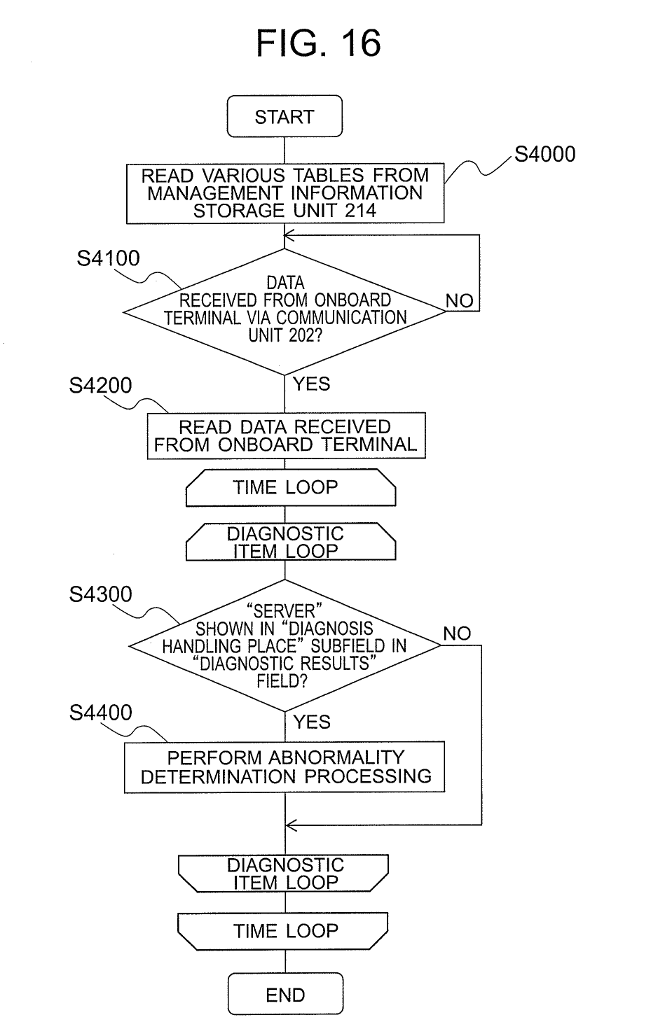

With reference to FIG. 16, a description will next be made about the contents of processing to be performed by the diagnostic processing unit 204 on the side of the server 200. In S4000, the diagnostic processing unit 204 first reads the various tables (see FIG. 15) stored in the management information storage unit 214. In S4100, the diagnostic processing unit 204 confirms if data have been received from the onboard terminal 100 via the communication unit 202. When confirmed to not have been received, the diagnostic processing unit 204 determines to be NO and repeats the determination processing of S4100. Upon confirmation of receipt of the data from the onboard terminal 100, on the other hand, the diagnostic processing unit 204 determines to be YES, and the control flow proceeds to the next step.

In S4200, the diagnostic processing unit 204 then reads the data received in S4100. The data which the diagnostic processing unit 204 handles are the data transmitted from the side of the onboard terminal 100, and therefore, are in the form of a data file of the format illustrated in FIG. 14. With reference to the data file of FIG. 14, a description will hereinafter be made about the contents of processing. Upon completion of the reading of the data file in S4200, the diagnostic processing unit 204 performs the processing of S4300 and S4400 on the data file, which is illustrated in FIG. 14 and has been received from the onboard terminal 100, by time data and diagnostic item in the area labeled “data”.

In S4300, the diagnostic processing unit 204 first reads the information of the field labeled “diagnostic results” under each target diagnostic item of a target time in the data file illustrated in FIG. 14 and received from the onboard terminal 100, and confirms if the subfield labeled “diagnosis handling place” reads the keyword of the server. The diagnostic processing unit 204 determines to be NO when the subfield labeled “diagnosis handling place” reads the onboard terminal 100, but determines to be YES when the subfield labeled “diagnosis handling place” reads the server 200. When the determination of NO is made, the diagnostic processing has already been performed on the side of the onboard terminal 100 with respect to the target diagnostic item of the target time, and therefore, the diagnostic processing is skipped. When the determination of YES is made, on the other hand, the diagnostic processing unit 204 performs abnormality determination processing in S4400.

The abnormality determination processing to be performed by the diagnostic processing unit 204 is the same as the abnormality determination processing performed by the diagnostic processing unit 104, in other words, S3150 in FIG. 13. Although the detailed description of the processing is hence omitted herein, the diagnostic processing unit 204 performs, in S4400, abnormality determination processing on the sensor data, which is recorded in the subfield labeled “operation data for diagnostic processing” of the data file illustrated in FIG. 14, with reference to the sensor information, diagnostic item table, diagnostic model table and diagnostic condition table for onboard terminal, which are stored in the management information storage unit 214. The diagnostic processing unit 204 then records the result of the abnormality determination processing in the subfield labeled “abnormality determination result” in the field labeled “diagnostic results” of the data file illustrated in FIG. 14. After the foregoing processing has been performed for every time and diagnostic item, the diagnostic processing unit 204 outputs the data file to the diagnostic result storage unit 206, and ends the processing.

As has been described above, this embodiment can set to perform primary diagnoses of the working machine 1 at the onboard terminal 100 and to perform secondary diagnoses of the working machine 1 at the server 200, and therefore, can reduce the load of each processing. At a site such as a mine where the status of communication does not remain stable, it is possible to perform up to the secondary diagnoses at the onboard terminal 100 provided that the dynamic switching of diagnostic conditions is set to be valid. The diagnoses of the working machine 1 can, therefore, be reliably performed even under such a situation that data cannot be transmitted to the server 200. It is, accordingly, possible to find an abnormality of the working machine at an early stage and to reduce the downtime of the working machine 1.

Because the “valid” setting of a hierarchical diagnosis makes it possible to perform a diagnosis of Lv2 only when the result of a diagnosis of Lv1 is abnormal, the processing load on the onboard terminal 100 or server 200, which handles the processing of the diagnosis of Lv2, can be reduced further. In addition, diagnostic items are provided for each part of system of the working machine 1 so that detailed diagnoses are possible. Moreover, with respect to each diagnostic item, the normal reference values for the respective operation modes of the working machine 1 are provided, and therefore, an abnormality can be found at an early stage in each operation mode.

At a site of good communication status, it is possible to configure such that primary diagnoses are performed at the server 200 and secondary diagnoses are performed at the onboard terminal 100. Described specifically, various sensor data of the working machine 1 are all transmitted from the onboard terminal 100 to the server 200, and primary diagnoses are performed on the side of the server 200. The results of these diagnoses are transmitted to the onboard terminal 100. The onboard terminal 100 is configured to perform one or more secondary diagnoses only when the received result or results of the corresponding primary diagnosis or diagnoses are “abnormal”. Even in this configuration, the processing load on each of the onboard terminal 100 and server 200 can be reduced. Moreover, an abnormality of the working machine 1 can be reliably found provided that the primary diagnoses and secondary diagnoses are configured to be performed at the onboard terminal 100 when a trouble occurs in the communication status.

In principle, it is also possible to configure to perform primary diagnoses and secondary diagnoses at the server 200, to transmit only the results of the respective diagnoses to the onboard terminal 100, and, only when the processing load on the side of the server 200 is determined to be high or only when a trouble occurs in the communication status, to perform the primary analyses and secondary analyses at the onboard terminal 100. Even in this configuration, the processing load on each of the onboard terminal 100 and server 200 can be reduced, and moreover, an abnormality of the working machine 1 can be reliably found.

It is to be noted that the above-described embodiment is merely illustrative for the description of the present invention and is not intended to limit the scope of the present invention to the embodiment only. Those having ordinary skill in the art can carry out the present invention in various other modes without departing from the gist of the present invention.

For example, the present invention can be applied to systems for diagnosing abnormalities of self-propelled working machines used in worksites, such as wheel loaders and cranes, and also to systems for diagnosing abnormalities of automobiles and railroad vehicles. Therefore, the present invention can be widely used in the entire range of systems that perform abnormality diagnoses of self-propelled machines.

1. A diagnostic processing system comprising an onboard terminal system, which is mounted on a self-propelled machine, and a server, which is arranged at a control center, connected together via radio communication channels, wherein:
the onboard terminal system is provided with a data receiving unit for receiving data from sensors arranged on the self-propelled machine and a first diagnostic unit for diagnosing an abnormality of the self-propelled machine,
the server is provided with a second diagnostic unit for diagnosing the abnormality of the self-propelled machine, and
one of the first diagnostic unit and second diagnostic unit performs a primary diagnosis of the abnormality of the self-propelled machine based on the data received at the data receiving unit and transmits a result of the primary diagnosis to the other diagnostic unit, and upon receipt of the result of the primary diagnosis, the other diagnostic unit performs a secondary diagnosis based on the result of the primary diagnosis.

2. The diagnostic processing system according to claim 1, wherein:
the first diagnostic unit performs the primary diagnosis, the second diagnostic unit performs the secondary diagnosis upon receipt of the result of the primary diagnosis by the first diagnostic unit, and based on satisfaction of a predetermined condition, the first diagnostic unit further also performs the secondary diagnosis.

3. The diagnostic processing system according to claim 2, wherein:
the primary diagnosis is a simple diagnosis that performs a predetermined diagnostic content by using a simple method,
the secondary diagnosis is a detailed diagnosis that performs the predetermined diagnostic content by using a detailed method, and
the first diagnostic unit or second diagnostic unit performs the secondary diagnosis only when the self-propelled machine has been found to be abnormal as a result of the primary diagnosis.

4. The diagnostic processing system according to claim 3, wherein:
a method that compares the data with a predetermined threshold is used as the simple method, and
a method that subjects the data to a multivariate analysis is used as the detailed method.

5. The diagnostic processing system according to claim 3, wherein:
the predetermined diagnostic content is set for every operation mode of the self-propelled machine.

6. The diagnostic processing system according to claim 3, wherein:
the predetermined diagnostic content is set for every diagnostic target of the self-propelled machine.

7. The diagnostic processing system according to claim 6, wherein:
the self-propelled machine is a hydraulic excavator,
at least an engine and a hydraulic system are included as diagnostic targets, and
items for detecting an abnormality of a cooling system, an abnormality of an intake system and an abnormality of an exhaust temperature in the engine and an item for detecting an abnormality of a hydraulic oil cooling system in the hydraulic system are included as predetermined diagnostic contents.

8. The diagnostic processing system according to claim 2, wherein:
the onboard terminal system is provided with a communication status determination unit for determining a communication status of the radio communication channels, and the predetermined condition is supposed to be satisfied when the communication status of the radio communication channels is determined to be not good by the communication status determination unit.

9. An onboard terminal system to be mounted on a self-propelled machine to perform communication with a server, which is arranged at a control center, via radio communication channels, wherein:
the onboard terminal system is provided with:
a data receiving unit for receiving data from sensors arranged on the self-propelled machine,
a first diagnostic unit for performing, based on the data received from the data receiving unit, a primary diagnosis as to an abnormality of the self-propelled machine,
a first communication unit for transmitting, to the server, a result of the primary diagnosis at the first diagnostic unit, and
a communication status determination unit for determining a communication status of the radio communication channels; and
the first diagnostic unit further performs, according to a result of the determination by the communication status determination unit, a secondary diagnosis as to the abnormality of the self-propelled machine.

10. A server to be arranged at a control center to perform communication with an onboard terminal system, which is mounted on a self-propelled machine, via radio communication channels, wherein:
the server is provided with:
an input unit for inputting a condition for a primary diagnosis to be performed at the onboard terminal system as to an abnormality of the self-propelled machine,
a second communication unit for transmitting, to the onboard terminal system, the condition for the primary analysis as inputted at the input unit and also for receiving, from the onboard terminal system, a result of the primary diagnosis performed at the onboard terminal system, and
a second diagnostic unit for performing a secondary diagnosis as to the abnormality of the self-propelled machine based on the result of the first diagnosis as received at the second communication unit.
